(19) United States
(12) Patent Application Publication
(10) Pub. No.: US 2025/0098703 A1
(43) Pub. Date: Mar. 27, 2025

(54) Preparation of Sunflower Protein Products ("SF870")

(71) Applicant: Burcon Nutrascience (MB) Corp., Winnipeg (CA)

(72) Inventors: Martin SCHWEIZER, Winnipeg (CA); Randy WILLARDSEN, Roseville, CA (US)

(21) Appl. No.: 18/832,734

(22) PCT Filed: Jan. 24, 2023
(86) PCT No.: PCT/CA2023/050081

§ 371 Date: Jul. 24, 2024

Related U.S. Application Data
(60) Provisional application No. 63/302,299, filed on Jan. 24, 2022.

(51) Int. Cl. A23J 1/14; A21D 2/26; A23J 3/14; A23K 20/147; A23L 2/66; A23L 27/60

(52) U.S. Cl. CPC A23J 1/14; A21D 2/266; A23J 3/14; A23K 20/147; A23L 2/66; A23L 27/66

(57) ABSTRACT

A process for preparing a sunflower protein product from a sunflower protein source, the sunflower protein product having a protein content of greater than 60 wt % (N×6.25) d.b, is provided. A sunflower protein product as well as a residual sunflower protein product are also provided as are food and beverages, pet food, animal feed, industrial product, cosmetic product or personal care product comprising the sunflower protein product as well as a residual sunflower protein product.

### RELATED APPLICATION

This application claims priority to U.S. Provisional Patent Application 63/302,299 filed Jan. 24, 2022, herein incorporated by reference in its entirety.

### FIELD OF THE INVENTION

The present invention relates to novel and inventive sunflower protein products and to novel and inventive methods of preparing sunflower protein products.

### SUMMARY OF THE INVENTION

The present invention relates to novel and inventive sunflower products, processes for the preparation thereof and products comprising them.

In one embodiment, the present invention provides for a process for preparing a sunflower protein product from a sunflower protein source, the sunflower protein product having a protein content of greater than 60 wt % (N×6.25) d.b, the process comprising
extracting sunflower protein from a sunflower protein source to cause solubilization of the sunflower protein from the sunflower protein source to produce an aqueous phase and a residual sunflower protein source;
separating the aqueous phase from the residual sunflower protein source to produce an aqueous sunflower protein solution and a separated residual sunflower protein source
optionally defatting the separated aqueous sunflower protein solution to at least partially remove fat from the separated aqueous sunflower protein solution;
optionally adjusting the pH of the aqueous sunflower protein solution to a higher value not exceeding about pH 8.0;
optionally concentrating the aqueous sunflower protein solution to provide a concentrated sunflower protein solution having a protein concentration of about 5 to about 30 wt %, preferably about 5 to about 20 wt %, more preferably about 10 to about 20 wt %;
optionally diafiltering the concentrated sunflower protein solution using water as the diafiltration solution OR diafiltering the aqueous sunflower protein solution prior to concentration or diafiltering the partially concentrated aqueous sunflower protein solution;
optionally drying the sunflower protein solution or optionally concentrated and/or diafiltered sunflower protein solution to provide a sunflower protein product;
wherein steps e) and f) may optionally be carried out simultaneously.

In a further embodiment of the process or processes as outlined above, the process further comprises:
treating the aqueous sunflower protein solution with an anti-foamer, such as any suitable food-grade, non-silicone based anti-foamer, to reduce the volume of foam formed upon further processing, and wherein the anti-foamer is optionally added during the extraction step a).

In a further embodiment of the process or processes as outlined above, the quantity of anti-foamer employed is generally greater than about 0.0003% w/v.

In a further embodiment of the process or processes as outlined above, the process further comprises:
treating the aqueous sunflower protein solution with an adsorbent, such as granulated activated carbon, to remove colour and/or odour compounds.

In a further embodiment of the process or processes as outlined above, separation comprises centrifugation and/or filtration optionally with a decanter centrifuge and a disc stack centrifuge.

In a further embodiment of the process or processes as outlined above, defatting of the separated aqueous sunflower protein solution is achieved by centrifugation and/or filtration.

In a further embodiment of the process or processes as outlined above, defatting comprises the use of a three-phase centrifuge, such as a three-phase separator, for the simultaneous separation of fat and residual solids from the protein solution, and wherein the three-phase centrifuge is optionally used potentially instead of or in addition to the separation steps defined above.

In a further embodiment of the process or processes as outlined above, solubilization from the sunflower protein source is effected using water having different levels of purity such as tap water or reverse osmosis (RO) purified water.

In a further embodiment of the process or processes as outlined above, a pH of the extraction may be the natural pH of the combination of the water and the sunflower protein source, or the pH of the extraction may be adjusted up to any value between the natural pH and about 8.0, or the pH may be adjusted within the range of about 6.8 to about 8.0, or the pH may be adjusted to about 6.8 to about 7.5.

In a further embodiment of the process or processes as outlined above, a food grade sodium hydroxide, potassium hydroxide or any other conventional food grade alkali and combinations thereof are added to the water to adjust the pH of the extraction.

In a further embodiment of the process or processes as outlined above, solubilization of the protein is effected at a temperature of from about 1° to about 100° C., preferably about 15° to about 65° C., more preferably about 50° C. to about 60° C., optionally accompanied by agitation.

In a further embodiment of the process or processes as outlined above, the solubilization time is about 1 to about 60 minutes, preferably about 10 to about 30 minutes.

In a further embodiment of the process or processes as outlined above, the concentration of the sunflower protein source in the water during the extraction step is about 5 to about 20% w/v, preferably about 5 to about 15% w/v.

In a further embodiment of the process or processes as outlined above, the aqueous phase resulting from the extraction step generally has a protein concentration of about 0.5 to about 5 wt %, preferably about 1 to about 5 wt %.

In a further embodiment of the process or processes as outlined above, the water of extraction contains an antioxidant, such as ascorbic acid optionally in an amount of from about 0.01 to about 1 wt % of the solution, preferably about 0.05 wt % to about 0.15 wt %, more preferably about 0.05 wt % to about 0.10 wt %.

In a further embodiment of the process or processes as outlined above, the separation step b) is conducted at the same temperature as the extraction step or at any temperature within the range of about 1° to about 100° C., preferably about 15° to about 65° C., more preferably about 50° to about 60° C.

In a further embodiment of the process or processes as outlined above, the concentration step e) is effected by selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 10,000 to about 100,000 daltons.

In a further embodiment of the process or processes as outlined above, the diafiltration step f) is effected using water as the diafiltration solution without any pH adjustment or the water is adjusted with any food grade alkali to a pH up to that of the optionally concentrated sunflower protein solution.

In a further embodiment of the process or processes as outlined above, diafiltration is effected using from about 1 to about 40 volumes of diafiltration solution, preferably about 2 to about 25 volumes of diafiltration solution, more preferably about 2 to about 5 volumes of diafiltration solution.

In a further embodiment of the process or processes as outlined above, diafiltration is effected using the same membrane as for the concentration step e) or the diafiltration step f) is effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons.

In a further embodiment of the process or processes as outlined above, a further concentration step is applied after the diafiltration step.

In a further embodiment of the process or processes as outlined above, the concentration step and/or the diafiltration step are effected in such a manner that the sunflower protein product subsequently recovered contains at least about 60 wt %, at least about 65 wt %, at least about 70 wt %, at least about 75 wt %, at least about 80 wt %, at least about 85 wt %, or greater than about 90 wt % protein (N×6.25) d.b.

In a further embodiment of the process or processes as outlined above, the diafiltration water comprises an antioxidant, such as ascorbic acid, optionally in an amount of from about 0.01 to about 1 wt %, preferably about 0.05 wt % to about 0.15 wt %, more preferably about 0.05 wt % to about 0.10 wt %.

In a further embodiment of the process or processes as outlined above, the optional concentration step e) and the optional diafiltration step f) are effected at generally about 2° to about 65° C., preferably about 50° to about 60° C.

In a further embodiment of the process or processes as outlined above, the concentrated and/or diafiltered protein solution are subject to a further defatting step.

In a further embodiment of the process or processes as outlined above, the concentrated and/or diafiltered protein solution are treated with an adsorbent, such as granulated activated carbon, to remove colour and/or odour compounds.

In a further embodiment of the process or processes as outlined above, the concentration and/or diafiltration steps are operated in a manner favourable for removal of trypsin inhibitors in the permeate, optionally by using a membrane of larger pore size, such as 30,000 to 1,000,000 Da, operating the membrane at elevated temperatures, such as about 30° to about 65° C., preferably about 50° to about 60° C. and employing greater volumes of diafiltration medium, such as 10 to 40 volumes.

In a further embodiment of the process or processes as outlined above, the aqueous sunflower protein solution is exposed to reducing agents that at least partially disrupt or rearrange the disulfide bonds of the inhibitors, such as sodium sulfite, cysteine or N-acetylcysteine.

In a further embodiment of the process or processes as outlined above, the optionally concentrated and optionally diafiltered protein solution is pasteurized prior to optional drying or further processing and wherein pasteurization optionally comprises heating the optionally concentrated and optionally diafiltered sunflower protein solution to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° to about 35° C.

In a further embodiment of the process or processes as outlined above, the optionally concentrated and optionally diafiltered protein solution is jet cooked prior to optional drying, to a temperature of about 110° C. to about 150° C. for about 10 seconds to about 1 minute, preferably about 135° C. to about 145° C. for about 40 to 50 seconds.

In a further embodiment of the process or processes as outlined above, the optionally concentrated, optionally diafiltered and optionally pasteurized sunflower protein solution is subject to drying step g) by any conventional means such as spray drying or freeze drying to provide a sunflower protein product.

In a further embodiment of the process or processes as outlined above, the dried sunflower protein product is heat treated in moistened air so as to modify the functional properties of the protein product.

In a further embodiment of the process or processes as outlined above, the heat treated dried sunflower protein product has an improved ability to form heat set gels.

In a further embodiment of the process or processes as outlined above, the process further comprises:
bi) optionally further processing the separated residual sunflower protein source obtained in step b), such as to recover residual protein;
bii) optionally re-extracting the separated residual sunflower protein source obtained in step b) with fresh water to recover residual protein and separating the re-extraction protein solution from the residual sunflower protein source and optionally combining the re-extraction protein solution with the aqueous sunflower protein solution for further processing;
biii) optionally using the separated residual sunflower protein source obtained in step b) or step bi) or step bii) as an ingredient in foods; and/or
biv) optionally using the separated residual sunflower protein source obtained in step b) or step bi) or step bii) as an ingredient in a pet food, animal feed, industrial product, cosmetic product or personal care product.

In a further embodiment of the process or processes as outlined above, in step biii), the separated residual sunflower protein source is pasteurized and/or dried before use as an ingredient in foods.

In a further embodiment of the process or processes as outlined above, in step biii), the sunflower protein source is dehulled material.

In a further embodiment of the process or processes as outlined above, in step biii), the separated residual sunflower protein source has a protein content of less than about 55% (N×6.25) d.b., preferably about 20.04 to about 46.36% (N×6.25) d.b.

In a further embodiment of the process or processes as outlined above, step a) is carried out using a counter-current extraction procedure.

In a further embodiment of the process or processes as outlined above, finer solids are captured separately from the bulk of the separated residual sunflower protein source in step b), optionally by the disc stack centrifuge, are optionally diluted with water, optionally RO water, then optionally dried to form a sunflower protein product having a protein content of at least about 45 wt % (N×6.25), preferably at least about 50, 55 or 60 wt % (N×6.25) d.b., more preferably at least about 65 wt % (N×6.25) d.b.

In a further embodiment of the process or processes as outlined above, the pH of the optionally diluted finer solids is raised to a value between the natural pH of the solids and a pH of about 8.0, by any conventional means such as by the addition of sodium hydroxide, potassium hydroxide or any other conventional food grade alkali and combinations thereof, prior to optional drying to form a sunflower protein product having a protein content of at least about 45 wt % (N×6.25), preferably at least about 50, 55 or 60 wt % (N×6.25) d.b., more preferably at least about 65 wt % (N×6.25) d.b.

In a further embodiment of the process or processes as outlined above, the finer solids captured separately from the bulk of the separated residual sunflower protein source in step b), optionally by the disc stack centrifuge, are washed in order to remove contaminants and improve the purity and flavour of the product, optionally by suspending the solids in between about 1 and about 20 volumes, preferably about 1 to about 10 volumes of wash solution such as water, preferably RO water, and optionally the washing step is conducted at any conventional temperature such as about 15° to about 65° C., preferably about 50° to about 60° C., and optionally for any conventional length of time, preferably 15 minutes or less, then a separation step is performed by any conventional means such as by centrifugation using a disc stack centrifuge to provide washed finer solids and a used wash solution.

In a further embodiment of the process or processes as outlined above, the used wash solution is optionally added to the aqueous sunflower protein solution arising from the separation step b) for further processing.

In a further embodiment of the process or processes as outlined above, the washed finer solids are optionally diluted with water then optionally dried by any conventional means such as spray drying or freeze drying to provide a sunflower protein product having a protein content of at least about 45 wt % (N×6.25) d.b., preferably about 50, 55, 60 or 65 wt % (N×6.25) d.b., more preferably about 70 wt % (N×6.25) d.b.

In a further embodiment of the process or processes as outlined above, the pH of the optionally diluted washed finer solids is adjusted to a value between the natural pH of the mixture of finer solids and water and about 8.0, by any conventional means such as by the addition of sodium hydroxide, potassium hydroxide or any other conventional food grade alkali and combinations thereof, prior to optional drying.

In a further embodiment of the process or processes as outlined above, the finer solids are pH adjusted during the washing step by adjusting the mixture of finer solids and wash solution to a pH between the natural pH of the mixture and about 8.0 using food grade alkali solution, then separating the washed solids from the used wash solution by centrifugation and optionally diluting the washed solids with water and optionally drying the washed solids.

In a further embodiment of the process or processes as outlined above, the used wash solution is added to the aqueous sunflower protein solution arising from the separation step b) for further processing.

In a further embodiment of the process or processes as outlined above, the process further comprises pasteurizing the optionally diluted and optionally pH adjusted finer solids or optionally diluted and optionally pH adjusted washed finer solids prior to the optional drying step, wherein pasteurization optionally comprises heating to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds.

In a further embodiment of the process or processes as outlined above, the pasteurized optionally diluted and optionally pH adjusted finer solids or optionally diluted and optionally pH adjusted washed finer solids is cooled, such as to a temperature of about 20° to about 35° C.

In a further embodiment of the process or processes as outlined above, the optionally diluted and optionally pH adjusted finer solids or optionally diluted and optionally pH adjusted washed finer solids are jet cooked prior to optional drying, at a temperature of about 110° C. to about 150° C. for about 10 seconds to about 1 minute, preferably about 135° C. to about 145° C. for about 40 to 50 seconds.

In a further embodiment of the process or processes as outlined above, the extraction is carried out in a continuous operation or a batch operation.

In a further embodiment, the present invention provides for a sunflower protein product having a solubility of less than about 70% when measured at pH 4, less than about 25% when measured at pH 5.5 and greater than about 50% when measured at pH 7, preferably about 0.8 to about 67.5% when measured at pH 4, about 6.6 to about 19.9% when measured at pH 5.5 and about 53.7 to about 97.8% when measured at pH 7.

In a further embodiment of a sunflower protein product or products as outlined above, the product has a solubility of about 46.3 to about 67.5% when measured at pH 4, about 10.4 to about 19.9% when measured at pH 5.5 and about 53.7 to about 97.8% when measured at pH 7.

In a further embodiment of a sunflower protein product or products as outlined above, the product has a solubility of about 9.5 to about 17.6% when measured at pH 4, about 4.9 to about 14.7% when measured at pH 5.5 and about 22.4 to about 36.8% when measured at pH 7.

In a further embodiment, the present invention provides for a sunflower protein product having an amino acid profile for cysteine and methionine as defined in Table 7.

In a further embodiment, the present invention provides for a sunflower protein product having an amino acid profile for threonine, valine, isoleucine, leucine, tyrosine, phenylalanine, lysine, histidine, cysteine, methionine and tryptophan as defined in Table 7.

In a further embodiment, the present invention provides for a sunflower protein product having a phytic acid content of less than about 1.5% d . . . b., preferably less than about 0.97% d.b.

In a further embodiment, the present invention provides for a sunflower protein product having a chlorogenic acid content of less than about 10,000 ppm d.b., preferably less than about 9,518 ppm d.b.

In a further embodiment of the product or products outlined above, the chlorogenic acid content is less than about 565 ppm d.b.

In a further embodiment of the product or products outlined above, the chlorogenic acid content is between about 179 to about 565 ppm d.b.

In a further embodiment, the present invention provides for a sunflower protein product having an ash content of 3% d.b. or less, preferably about 2.75% d.b. or less.

In a further embodiment, the present invention provides for a sunflower protein product having a sodium content of less than about 0.4% d.b., preferably less than about 0.19% d.b.

In a further embodiment, the present invention provides for a sunflower protein product having a HPLC profile as determined by the method in Example 32, wherein the peak having the largest peak area with a retention time of less than 10 minutes has a retention time of about 6.253 to about 6.699 minutes and a peak area of about 2,716,517 to about 4,901,552.

In a further embodiment of the product or products outlined above, the sunflower protein product is derived from confectionery or non-oilseed or black oil or oilseed or conoil sunflower seed.

In a further embodiment of the product or products outlined above, the sunflower protein product is derived from dehulled sunflower seed.

In a further embodiment of the product or products outlined above, the sunflower protein product is derived from a partially or fully defatted sunflower protein source.

In a further embodiment, the present invention provides for a residual sunflower protein product comprising a protein content of less than about 55% (N×6.25) d.b., preferably about 20.04 to about 46.36% (N×6.25) d.b.

In a further embodiment of the residual sunflower protein product or products outlined above, the sunflower protein source material is dehulled material and the residual sunflower protein source material is optionally pasteurized and optionally dried.

In a further embodiment of the residual sunflower protein product or products outlined above, the residual protein product is produced by the processes outlined above and/or herein.

In a further embodiment of the residual sunflower protein product or products outlined above, the residual protein product is further combined with captured finer solids.

In a further embodiment, the present invention provides for a sunflower protein product or a residual sunflower protein product having an attribute from one or more of the following tables:
a protein content as defined in or captured by Table 2;
a solubility as defined in or captured by Table 3,
a dry colour as defined in or captured by Table 4;
a water binding capacity as defined or captured by Table 5;
an oil binding capacity as defined in or captured by Table 6;
a phytic acid content as defined in or captured by Table 7;
an amino acid profile comprising one or more amino acids as defined or captured by Table 8;
a chlorogenic acid content as defined or captured by Table 9;
an acid hydrolysis fat content as defined or captured by Table 10;
an ash content as defined or captured by Table 11;
a viscosity as defined or captured by Table 12;
an emulsion absorbance reading as defined or captured by Table 13
a sodium content as defined or captured by Table 19; and/or
an HPLC profile as defined or captured by Table 20.

In a further embodiment, the present invention provides for a pet food, animal feed, industrial product, cosmetic product or personal care product comprising a sunflower protein product such as that produced by the process or processes outlined above and/or herein, a sunflower protein product outlined above and/or herein, or a residual sunflower protein product as outlined above and/or herein.

In a further embodiment, the present invention provides for a food or beverage comprising a sunflower protein product such as that produced by the process or processes outlined above and/or herein, a sunflower protein product as outlined above and/or herein, or a residual sunflower protein product as outlined above and/or herein.

In a further embodiment of the food or beverage or beverages outlined above, the food or beverage is:
a dairy alternative,
a meat alternative,
a seafood alternative,
a grain product,
a snack or sweet,
a fats and oils product,
a condiment or sauce, or
a nutritional product.

In a further embodiment of the food or beverage or beverages outlined above, the dairy alternative is:
a milk alternative beverage,
a frozen dessert,
a cheese alternative, or
a yogurt alternative.

In a further embodiment of the food or beverage or beverages outlined above, the meat alternative is:
a beef alternative,
a pork alternative, or
a poultry alternative.
   a. In a further embodiment of the food or beverage or beverages outlined above, the seafood alternative is:
a tuna alternative,
a salmon alternative, or
a shrimp alternative.

In a further embodiment of the food or beverage or beverages outlined above, the grain product is:
a pasta,
a bread, or
a breakfast cereal.

In a further embodiment of the food or beverage or beverages outlined above, the snack or sweet is:
a cookie,
a cracker,
a bar product, or
a cake.

In a further embodiment of the food or beverage or beverages outlined above, the fats and oils product is:
a margarine, or
a dressing.

In a further embodiment of the food or beverage or beverages outlined above, the condiment or sauce is:
a tomato based sauce,
a non tomato based sauce,
a dip; or
a gravy.

In a further embodiment of the food or beverage or beverages outlined above, the nutritional product is:
a nutritional drink; or
a nutritional powder.

In a further embodiment of the food or beverage or beverages outlined above, the food or beverage is:
a sports drink;
an energy drink; or
a smoothie.

### DETAILED DESCRIPTION

The initial step of the process of providing the sunflower protein products of the present invention involves solubilizing sunflower protein from a sunflower protein source. The sunflower protein source may be any variety of sunflower seed used for human food or animal feeding purposes. Confectionery (also known as non-oilseed), black oil (also known as oilseed) and conoil types of sunflower seed may be used. The sunflower protein source may be used in the full fat form, partially defatted form (e.g. cold pressed cake/meal) or fully defatted form (e.g. pressed and solvent extracted meal). For the purpose of this disclosure, the terms “cake” and “meal” are used interchangeably. “Cake” is generally yielded from pressing and the solvent extraction of the cake yields a “meal”. Meal may also be considered a ground presscake. Pressed sunflower, encompassed by the terms “cake” and “meal” may be added to extraction solution without a grinding step when it is generally soft enough that it fragments when mixed with water or other appropriate solvent or liquid. The sunflower protein source may contain hulls (i.e. derived from seeds with hulls) or may be dehulled material (i.e. derived from seeds with the hulls removed, also known as kernels). Preferably the sunflower protein source is dehulled and defatted prior to use in the processes of the invention. Where the sunflower protein source contains an appreciable amount of fat, an oil removal step generally is required during the process. The particle size of the sunflower protein source may vary but it is preferred that the sunflower protein source is in the form of granules or a powder to facilitate more rapid wetting and more thorough mixing with the extraction solution. As mentioned above, some sunflower protein sources, such as certain cakes/meals from cold pressing, will fragment when mixed with extraction solution. The sunflower protein source may also be ground before the extraction step to achieve a desired particle size. The sunflower protein recovered from the sunflower protein source may be the protein naturally occurring in the sunflower seed or the proteinaceous material may be a protein modified by genetic manipulation but possessing characteristic hydrophobic and polar properties of the natural protein.

The sunflower protein products of the present invention may be prepared from sunflower protein source by either a batch process or a continuous process or a semi-continuous process. Protein solubilization from the sunflower protein source material is effected using water. The water used may be tap water or water having different levels of purity. Reverse osmosis (RO) purified water is preferred.

The pH of the extraction may be the natural pH of the combination of the water and the sunflower protein source, or the pH of the extraction may be adjusted up to any value between the natural pH and about 8.0, preferably the pH is adjusted within the range of about 6.8 to about 8.0, more preferably the pH is adjusted to about 6.8 to about 7.5. Food grade sodium hydroxide, potassium hydroxide or any other conventional food grade alkali and combinations thereof may be added to the water to adjust the pH of the extraction as required. The food grade alkali is preferably added in aqueous solution form.

The solubilization of the protein is effected at a temperature of from about 1° to about 100° C., preferably about 15° to about 65° C., more preferably about 50° C. to about 60° C., preferably accompanied by agitation to decrease the solubilization time, which is usually about 1 to about 60 minutes, preferably about 10 to about 30 minutes. It is preferred to effect the solubilization to extract substantially as much protein from the sunflower protein source as is practicable, so as to provide an overall high product yield. The pH values of the extraction and subsequent steps refer to values typically measured at room temperature (21-24° C.). For absence of doubt, when, for example, the extraction is conducted at an elevated temperature, the pH of the extraction mixture is such that a sample of extraction mixture cooled to room temperature has a pH reading in the specified range.

Extraction of the protein from the sunflower protein source, when conducted in a continuous operation, is carried out in any manner consistent with effecting a continuous extraction of protein from the sunflower protein source. In one embodiment, the sunflower protein source is continuously mixed with the water and the mixture is conveyed through a pipe or conduit having a length and at a flow rate for a residence time sufficient to effect the desired extraction in accordance with the parameters described herein.

The concentration of sunflower protein source in the water during the solubilization step may vary widely. Typical concentration values are about 5 to about 20% w/v, preferably about 5 to about 15% w/v.

It will be appreciated that reference to solubilizing encompasses both complete and partial solubilization of the protein from the sunflower protein source.

The protein extraction step has the additional effect of solubilizing fats which may be present in the sunflower protein source, which then results in the fats being present in the aqueous phase.

The protein solution resulting from the extraction step generally has a protein concentration of about 0.5 to about 5 wt %, preferably about 1 to about 5 wt %.

The water of extraction may contain an antioxidant. The antioxidant may be any conventional antioxidant, such as ascorbic acid or sodium sulfite. Preferably the antioxidant is ascorbic acid. The quantity of antioxidant employed may vary from about 0.01 to about 1 wt % of the solution, preferably about 0.05 to about 0.15 wt %, more preferably about 0.05 to about 0.10 wt %. The antioxidant serves to inhibit oxidation of phenolics present in the protein solution and preferably inhibits the development of green colouration that may occur in sunflower protein solutions at alkaline pH.

The aqueous phase resulting from the extraction step then may be separated from the residual sunflower protein source, in any conventional manner, such as by centrifugation and/or filtration. Preferably the aqueous phase resulting from the extraction step is separated from the bulk of the residual sunflower protein source using a decanter centrifuge and the resulting centrate further clarified using a disc stack centrifuge to remove finer solids. These finer solids may be combined with the residual solids collected from the decanter centrifugation and further processed as described below or may be further processed on their own to provide a product of the invention as described in greater detail starting in paragraph [0091]. The separation step may be conducted at the same temperature as the extraction step or at any temperature within the range of about 1° to about 100° C., preferably about 15° to about 65° C., more preferably about 50° to about 60° C. When the separation is done in more than one step (e.g. employing decanter centrifuge then disc stack centrifuge), different temperatures within the abovementioned range may employed for each step of the separation process. The separated residual sunflower protein source material (from the decanter step alone or combined with the finer solids from the disc stack centrifugation) may be used in food products, pet foods, animal feed and in industrial, cosmetic and personal care products, further processed to recover residual protein or disposed of. When this separated residual sunflower protein source material is used as a food ingredient, the sunflower protein source material is typically dehulled material and the separated residual sunflower protein source material is optionally pasteurized and optionally dried. When the separated residual sunflower protein source material is further processed to recover residual protein the residual protein may be recovered by re-extracting the separated residual sunflower protein source with fresh water and the protein solution yielded upon clarification combined with the initial protein solution for further processing as described below. A counter-current extraction procedure may also be utilized. The separated residual sunflower protein source may alternatively be processed by any other conventional procedure to recover residual protein. The residual sunflower protein source material remaining after the aforementioned processing to recover residual protein may also be used in food products, pet foods, animal feed and in industrial, cosmetic and personal care products. When this residual sunflower protein source material is used as a food ingredient, the sunflower protein source material is typically dehulled material and this residual sunflower protein source material is optionally pasteurized and optionally dried.

It will be appreciated that reference herein to a separation step and to separation of the aqueous phase and residual sunflower protein source is intended to refer to both complete separation as well as to at least partial separation. It is to be understood that trace or minor amounts of residual components may be found in the aqueous phase, for example but not limited to: residual protein source, finer solids, and/or fat/oil.

The aqueous sunflower protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

The separated aqueous sunflower protein solution may be subject to a defatting operation, if desired or required. Defatting of the separated aqueous sunflower protein solution may be achieved by any conventional procedure such as centrifugation and/or filtration. A three-phase centrifuge such as a three-phase separator may be used for the simultaneous separation of fat and residual solids from the protein solution with the three-phase centrifuge potentially being used instead of or in addition to the separation steps already described above. When a three-phase centrifuge is used in addition to the decanter and disc stack centrifuge described above, the order in which the disc stack and three-phase centrifuge steps are applied to the post-decanter protein solution may be varied. Solids collected by the three-phase centrifuge may be disposed of or further processed, alone or in combination with residual solids collected from the decanter centrifuge and/or disc stack centrifuge.

The aqueous sunflower protein solution may be treated with an adsorbent, such as granulated activated carbon, to remove colour and/or odour compounds. Such adsorbent treatment may be carried out under any conventional conditions, generally at the ambient temperature of the separated aqueous protein solution.

The aqueous sunflower protein solution may be adjusted in pH to a higher value not exceeding about pH 8.0. The increase in pH is believed to improve the flux rate of subsequent membrane processing.

If of adequate purity, the aqueous sunflower protein solution may be directly dried to produce a sunflower protein product having a protein content of greater than 60 wt % (N×6.25) d.b. To provide a sunflower protein product having a decreased impurities content, such as a sunflower protein isolate, the aqueous sunflower protein solution may be processed as described below prior to drying. Further processing as described below is also believed to have a beneficial effect on the flavour of the product.

The aqueous sunflower protein solution may be concentrated to provide a concentrated sunflower protein solution having a protein concentration of about 5 to about 30 wt %, preferably about 5 to about 20 wt %, more preferably about 10 to about 20 wt %. It will be appreciated that concentrations of less than about 5 wt % may be considered as partially concentrated.

The concentration step may be effected in any conventional manner consistent with batch or continuous operation, such as by employing any conventional selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 10,000 to about 100,000 daltons having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include low molecular weight materials extracted from the source material, such as carbohydrates, pigments, phenolic colour precursors such as chlorogenic acid, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated sunflower protein solution then may be subjected to a diafiltration step using water as the diafiltration solution. The water may be used as the diafiltration solution without any pH adjustment or the water may be adjusted with any food grade alkali to a pH up to that of the concentrated sunflower protein solution. Preferably the pH of the diafiltration solution water is equal to that of the protein solution being diafiltered. The diafiltration may also be done in stages using water at different pH values, such as initial volumes of diafiltration using water adjusted to the pH of the protein solution followed by additional volumes of diafiltration water without pH adjusting agent. Such diafiltration may be effected using from about 0.5 to about 40 volumes of diafiltration solution, preferably about 2 to about 25 volumes of diafiltration solution, more preferably about 2 to about 5 volumes of diafiltration solution. In the diafiltration operation, further quantities of contaminants are removed from the aqueous sunflower protein solution by passage through the membrane with the permeate. This purifies the aqueous protein solution and may also reduce its viscosity. The diafiltration operation may be effected until no significant further quantities of contaminants or visible colour are present in the permeate or until the retentate has been sufficiently purified so as to provide a sunflower protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons having regard to different membrane materials and configuration. If desired, the diafiltered protein solution may be further concentrated.

Alternatively, the diafiltration step may be applied to the aqueous protein solution prior to concentration or to partially concentrated aqueous protein solution. Diafiltration may also be applied at multiple points during the concentration process. When diafiltration is applied prior to concentration or to the partially concentrated solution, the resulting diafiltered solution may then be additionally concentrated. Diafiltering multiple times as the protein solution is concentrated may allow a higher final, fully concentrated protein concentration to be achieved. This reduces the volume of material to be dried. Diafiltration and concentration may also be conducted simultaneously.

The concentration step and the diafiltration step may be effected herein in such a manner that the sunflower protein product subsequently recovered contains less than about 90 wt % protein (N×6.25) d.b., such as at least about 60 wt % protein (N×6.25) d.b. By partially concentrating and/or partially diafiltering the aqueous sunflower protein solution, it is possible to only partially remove contaminants. This protein solution may then be dried to provide a sunflower protein product with lower levels of purity.

An antioxidant may be present in the diafiltration water during at least part of the diafiltration step. The antioxidant may be any conventional antioxidant, such as ascorbic acid or sodium sulfite. Preferably the antioxidant is ascorbic acid. The quantity of antioxidant employed in the diafiltration water depends on the materials employed and may vary from about 0.01 to about 1 wt %, preferably about 0.05 to about 0.15 wt %, more preferably about 0.05 to about 0.10 wt %. The antioxidant serves to inhibit oxidation of phenolics present in the protein solution and preferably inhibits the development of green colouration that may occur in sunflower protein solutions at alkaline pH.

The optional concentration step and the optional diafiltration step may be effected at any conventional temperature, generally about 2° to about 65° C., preferably about 50° to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

Sunflowers contain anti-nutritional trypsin inhibitors. The level of trypsin inhibitor activity in the final sunflower protein product can be controlled by the manipulation of various process variables.

The concentration and/or diafiltration steps may be operated in a manner favourable for removal of trypsin inhibitors in the permeate along with the other contaminants. Removal of the trypsin inhibitors is promoted by using a membrane of larger pore size, such as 30,000 to 1,000,000 Da, operating the membrane at elevated temperatures, such as about 30° to about 65° C., preferably about 50° to about 60° C. and employing greater volumes of diafiltration medium, such as 10 to 40 volumes.

Further, a reduction in trypsin inhibitor activity may be achieved by exposing sunflower materials to reducing agents that disrupt or rearrange the disulfide bonds of the inhibitors. Suitable reducing agents include, but are not limited to, sodium sulfite, cysteine and N-acetylcysteine.

The addition of such reducing agents may be effected at various stages of the overall process. The reducing agent may be added with the sunflower protein source material in the extraction step, may be added to the aqueous sunflower protein solution following removal of residual sunflower protein source material, may be added to the diafiltered retentate before drying or may be dry blended with the dried sunflower protein product. The addition of the reducing agent may be combined with the membrane processing steps, as described above.

If it is desired to retain active trypsin inhibitors in the protein solution, this can be achieved by not utilizing reducing agents, utilizing a concentration and diafiltration membrane with a smaller pore size as the sunflower trypsin inhibitor is a small molecule (˜1500 Da), operating the membrane at lower temperatures and employing fewer volumes of diafiltration medium.

The concentrated and/or diafiltered protein solution may be subject to a further defatting operation, if required. Defatting of the concentrated and/or diafiltered protein solution may be achieved by any conventional procedure.

The concentrated and/or diafiltered protein solution may be treated with an adsorbent, such as granulated activated carbon, to remove colour and/or odour compounds. Such adsorbent treatment may be carried out under any conventional conditions, generally at the ambient temperature of the protein solution.

The optionally concentrated and optionally diafiltered protein solution may be pasteurized prior to drying or further processing. Such pasteurization may be effected under any conventional pasteurization conditions. Generally, the optionally concentrated and optionally diafiltered sunflower protein solution is heated to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized sunflower protein solution then may be cooled, such as to a temperature of about 20° to about 35° C.

The optionally concentrated and optionally diafiltered aqueous sunflower protein solution may be jet cooked prior to drying in order to modify the functional properties of the protein product. In such jet cooking, the protein solution may be heated to a temperature of about 110 to about 150° C. for a time of about 10 seconds to about 1 minute. Preferably the product is heated to about 135° C. to about 145° C. for about 40 to 50 seconds.

The optionally concentrated, optionally diafiltered, optionally pasteurized and optionally jet cooked sunflower protein solution then may be dried by any conventional means such as spray drying or freeze drying to provide a sunflower protein product.

The sunflower protein product has a protein content greater than about 60 wt % (N×6.25) d.b. Preferably the sunflower protein product has a protein content greater than about 65, 70, 75, 80 and 85 wt % (N×6.25) d.b. Most preferably, the sunflower protein product is an isolate with a protein content in excess of about 90 wt % protein (N×6.25) d.b.

In accordance with another aspect of the present invention, the dried sunflower protein product prepared from the aqueous sunflower protein solution may be subjected to a heat treatment in moistened air to modify the functional properties of the protein product. Without wishing to be bound to any theory, it is believed that the heat treatment, conducted in moistened air, at a suitable temperature and for a suitable length of time introduces partial denaturation of the protein, thereby altering its functionality. In particular, such a controlled heat treatment results in a product with an improved ability to form heat set gels when in solution. It is believed that if the denaturation becomes too extensive (e.g. temperature too high, treatment too long) then the treated protein product will not exhibit this improved gelation behaviour.

The sunflower protein product prepared from the aqueous sunflower protein solution (with or without the aforementioned moistened air heat treatment) has organoleptic and functional properties making it suitable for use in various food and beverage products. The sunflower protein product has a particularly high solubility at pH 7. This makes it highly valuable for use in dairy alternative products including but not limited to milk alternative beverages, frozen desserts and plant based cheese and yogurt alternative products. Other food and beverage uses for the sunflower protein product include but are not limited to meat alternatives (for example beef alternatives, pork alternatives, poultry alternatives and the like), seafood alternatives (for example tuna alternatives, salmon alternatives, shrimp alternatives and the like), grain products (for example pastas, breads, breakfast cereals and the like), snacks and sweets (for example cookies, crackers, bars, cakes, candies, chocolates and the like), beverages (for example sports drinks, energy drinks, smoothies and the like), fats and oils products (for example margarines, dressings and the like), condiments and sauces (for example tomato based or non-tomato based sauces, dips, gravies and the like) and nutritional products (for example drinks, powders and the like). The sunflower protein product is rich in sulfur containing amino acids. The sunflower protein product may be formulated into a functional food or beverage. The sunflower protein product may be formulated into a food or beverage product to provide protein fortification. The sunflower protein product may be formulated into a food or beverage product to replace other protein ingredients (including as an extender in meat or dairy products) or to replace non-protein functional ingredients. Other uses of the sunflower protein product are in pet foods, animal feed and in industrial, cosmetic and personal care products.

In accordance with another aspect of the present invention, the finer solids captured by the disc stack centrifuge in the separation step may be further processed to provide a sunflower protein product. The finer solids may be optionally diluted with RO water then optionally dried to form a sunflower protein product having a protein content of at least about 50 wt % (N×6.25) d.b., preferably at least about 55 wt % (N×6.25) d.b., more preferably at least about 60 wt % (N×6.25) d.b. Alternatively, the pH of the optionally diluted finer solids may be raised to a value between the natural pH of the solids and a pH of about 8.0, by any conventional means such as by the addition of sodium hydroxide, potassium hydroxide or any other conventional food grade alkali and combinations thereof prior to optional drying to form a sunflower protein product having a protein content of at least about 50 wt % (N×6.25) d.b., preferably at least about 55 wt % (N×6.25) d.b., more preferably at least about 60 wt % (N×6.25) d.b. The food grade alkali is preferably added in aqueous solution form.

Preferably, the finer solids are washed in order to remove contaminants and improve the purity and flavour of the product. The finer solids may be washed by suspending the solids in between about 1 and about 20 volumes, preferably about 1 to about 10 volumes of water, preferably RO water. The washing step may be conducted at any conventional temperature such as about 15° to about 65° C., preferably about 50° to about 60° C. The finer solids are mixed with the wash solution for any conventional length of time, preferably 15 minutes or less. The finer solids may then be separated from the used wash solution by any conventional means such as by centrifugation using a disc stack centrifuge. The used wash solution may be added to the protein solution arising from the initial separation step for further processing as described above. The washed finer solids may be optionally diluted with water then optionally dried by any conventional means such as spray drying or freeze drying to provide a sunflower protein product having a protein content of at least about 50 wt % (N×6.25) d.b., preferably about 55, 60 and 65 wt % (N×6.25) d.b., more preferably about 70 wt % (N×6.25) d.b. Alternatively, the pH of the optionally diluted washed finer solids may be adjusted to a value between the natural pH of the mixture of finer solids and water and about 8.0, by any conventional means such as by the addition of sodium hydroxide, potassium hydroxide or any other conventional food grade alkali and combinations thereof, prior to optional drying. As a further alternative, the finer solids may be pH adjusted during the washing step by adjusting the mixture of finer solids and wash water to a pH between the natural pH of the mixture and about 8.0 using food grade alkali, then collecting the solids by centrifugation and optionally drying the solids. The food grade alkali is preferably added in aqueous solution form.

A pasteurization step may be employed on the optionally diluted and optionally pH adjusted finer solids or optionally diluted and optionally pH adjusted washed finer solids prior to the optional drying step. Such pasteurization may be effected under any conventional pasteurization conditions. Generally, the optionally diluted and optionally pH adjusted finer solids or optionally diluted and optionally pH adjusted washed finer solids are heated to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized optionally diluted and optionally pH adjusted finer solids or optionally diluted and optionally pH adjusted washed finer solids then may be cooled, such as to a temperature of about 20° to about 35° C.

The optionally diluted and optionally pH adjusted finer solids or optionally diluted and optionally pH adjusted washed finer solids may be jet cooked prior to drying in order to modify the functional properties of the protein product. In such jet cooking, the protein solution may be heated to a temperature of about 110 to about 150° C. for a time of about 10 seconds to about 1 minute. Preferably the product is heated to about 135° C. to about 145° C. for about 40 to 50 seconds.

The product derived from the finer solids may be lower in purity compared to the product derived from the protein solution. However, the quality of the product derived from the finer solids is such that the product is suitable for use in food and beverage applications as described above for the sunflower protein product prepared from the aqueous sunflower protein solution. Other uses of the sunflower protein product derived from the finer solids are in pet foods, animal feed and in industrial, cosmetic and personal care products.

### EXAMPLES

### Example 1

30 kg of comminuted, cold pressed black oil sunflower seed meal was combined with 300 L of reverse osmosis purified (RO) water having a temperature of 62° C., 0.15 kg of ascorbic acid and 0.78 kg of 25% NaOH solution. The mixture was stirred for 15 minutes. A portion of the suspended residual solids (100.13 kg) were removed by centrifugation using a decanter centrifuge to provide a protein solution having a protein content of 1.88 wt % and a pH of 7.14. The protein solution was then further clarified by centrifugation using a disc stack centrifuge to remove additional suspended (finer) residual solids (8.46 kg) and provide a protein solution having a protein content of 1.53 wt %. 250 L of this protein solution was then fed to a three-phase separator which removed 30.61 kg of oil phase and another 9.68 kg of suspended solids and provided 180 L of protein solution having a protein content of 1.55 wt %. This solution had a pH of 7.00.

The protein solution was then reduced in volume from 180 L to 45 L by concentration on a polyethersulfone membrane having a pore size of 10,000 daltons, operated at a temperature of about 45° C. The protein solution, with a protein content of 4.96 wt %, was then diafiltered on the same membrane with 225 L of RO water, with the diafiltration operation conducted at about 46° C. The diafiltered protein solution, having a protein content of 4.71 wt % was then further concentrated to a protein content of 8.14 wt %. This diafiltered and concentrated protein solution had a pH of 6.72. 27.96 kg of diafiltered and concentrated protein solution was pasteurized at about 61° C. for 15 minutes. 27.40 kg of pasteurized solution was spray dried to yield a product having a protein content of 89.03% (N×6.25) d.b. The product was termed SF06-G06-21A SF870N.

The residual solids collected in the decanter centrifugation step had a protein content of 5.08 wt % and a solids content of 16.75 wt % (30.33% protein (N×6.25) d.b.).

The finer residual solids captured in the disc stack centrifugation step had a protein content of 6.24 wt % and a solids content of 11.30 wt % (55.22% protein (N×6.25) d.b.).

Note all cited pH values were from measurements conducted with the sample at room temperature unless otherwise noted. The extraction slurry was noted as having a pH of 7.18 at 30° C. Protein determinations were by combustion analysis using a conversion factor of 6.25.

### Example 2

30 kg of black oil sunflower kernel meal (prepared by pressing between about 30-33° C.) was combined with 300 L of reverse osmosis purified (RO) water having a temperature of 61.5° C., 0.15 kg of ascorbic acid and 0.36 kg of 25% NaOH solution. The mixture was stirred for 10 minutes. A portion of the suspended residual solids (65.85 kg) were removed by centrifugation using a decanter centrifuge to provide a protein solution having a protein content of 1.90 wt % and a pH of 7.04. The protein solution was then further clarified by centrifugation using a disc stack centrifuge to remove finer residual solids (11.58 kg) and provide a protein solution having a protein content of 1.68 wt %. 260 L of this protein solution was then fed to a three-phase separator which removed 18.32 kg of oil phase and another 8.84 kg of suspended solids and provided 245 L of protein solution having a pH of 6.91, a protein content of 1.62 wt % and a dry matter content of 2.59%. The dry basis protein content of this material was therefore 62.55% (N×6.25) d.b.

The residual solids collected in the decanter centrifugation step had a protein content of 4.69 wt % and a solids content of 21.77 wt % (21.54% protein (N×6.25) d.b.).

An aliquot of finer residual solids from the disc stack centrifuge step having a protein content 4.90 wt % and a solids content of 8.89 wt % (55.12% protein (N×6.25) d.b.) was freeze dried. The dried material had an as-is protein content of 51.23 wt %. This product was termed SF09-J21-21A SF870PN-01. Another 11.28 kg of finer residual solids from the disc stack centrifugation step, having a protein content of 4.90 wt %, was combined with 45 L of RO water having a temperature of 50° C. The mixture was centrifuged with a disc stack centrifuge and 4.06 kg of washed finer solids and 56 L of used wash solution, having a protein content of 0.53 wt %, was collected. The washed finer solids were pasteurized at about 61° C. for 15 minutes. The pasteurized washed finer solids, having a protein content of 4.78 wt % and a solids content of 7.27% (65.75% protein (N×6.25) d.b.), were spray dried. The product was termed SF09-J21-21A SF870PN-02.

The protein solution and used wash solution were combined to provide a solution having a pH of 7.02 and a protein content of 1.43 wt %. This solution was reduced in volume from 300 to 70 L by concentration on a polyethersulfone membrane having a MWCO of 10,000 daltons operated at a temperature of about 49° C. The concentrated protein solution with a protein content of 5.15 wt % was then diafiltered on the same membrane with 350 L of RO water at about 52° C. and further concentrated to a protein content of 8.29 wt %. This protein solution was pasteurized at about 61° C. for 10 minutes. The pasteurized material was spray dried to yield a product having a protein content of 98.41% (N×6.25) d.b. This product was termed SF09-J21-21A SF870N.

Note all cited pH values were from measurements conducted with the sample at room temperature unless otherwise noted. The target pH of the extraction slurry was 7.1 but the actual slurry pH was not recorded. Protein determinations were by combustion analysis using a conversion factor of 6.25.

### Example 3

‘a’ kg of ‘b’ was combined with 300 L of reverse osmosis purified (RO) water having a temperature of 62° C., 0.15 kg of ascorbic acid and ‘c’ kg of 25% NaOH solution. The mixture was stirred for ‘d’ minutes. A portion of the suspended residual solids (‘e’ kg) were removed by centrifugation using a decanter centrifuge to provide a protein solution having a protein content of ‘f’ wt % and a pH of 7.27. The protein solution was then further clarified by centrifugation using a disc stack centrifuge to remove additional suspended (finer) residual solids (‘g’ kg) and provide a protein solution having a protein content of ‘h’ wt %. ‘i’ L of this protein solution was then fed to a three-phase separator which removed ‘j’ kg of oil phase and another ‘k’ kg of suspended solids and provided ‘l’ L of protein solution having a protein content of ‘m’ wt %. This solution had a pH of ‘n’.

The protein solution was then reduced in volume from ‘o’ L to ‘p’ L by concentration on a polyethersulfone membrane having a pore size of 10,000 daltons, operated at a temperature of about ‘q′° C. The protein solution, with a protein content of ‘r’ wt %, was then diafiltered on the same membrane with ‘s’ L of RO water, with the diafiltration operation conducted at about 53° C. The diafiltered protein solution, having a protein content of ‘t’ wt % was then further concentrated to a protein content of ‘u’ wt %. This diafiltered and concentrated protein solution had a pH of ‘v’. ‘w’ kg of diafiltered and concentrated protein solution was pasteurized at about ‘x’° C. for 1 minute. ‘y’ kg of pasteurized solution was spray dried to yield a product having a protein content of ‘z’ % (N×6.25) d.b. The product was termed ‘aa’ SF870N.

The residual solids collected in the decanter centrifugation step had a protein content of ‘ab’ wt % and a solids content of ‘ac’ wt % (‘ad’% protein (N×6.25) d.b.). A sample of these residual solids was freeze dried to provide a product having an as-is protein content of ‘ae’ wt %, termed ‘aa’ SM.

‘af’ kg of finer residual solids from the disc stack centrifugation step, having a protein content of ‘ag’ wt % and a solids content of ‘ah’ wt % (‘ai’% protein (N×6.25) d.b.), was combined with ‘aj’ L of ‘ak’ water having a temperature of ‘al’° C. The mixture was centrifuged with a disc stack centrifuge and ‘am’ kg of washed finer solids and ‘an’ L of used wash solution was collected. The washed finer solids were pasteurized at about 72° C. for ‘ao’ seconds. The pasteurized material was spray dried to provide a product having a protein content of ‘ap’ % (N×6.25) d.b. The product was termed ‘aa’ SF870PN.

Note all cited pH values were from measurements conducted with the sample at room temperature unless otherwise noted. For both K01 and K02 the extraction slurry was noted as having a pH of 7.1 when measured at 60° C. and 7.27 when measured at room temperature. Protein determinations were by combustion analysis using a conversion factor of 6.25.

TABLE 1
Process parameters for the preparation of sunflower protein product

| aa | SF10-K01-21A | SF08-K02-21A |
|---|---|---|
| a | 30.1 | 30 |
| b | black oil sunflower kernel | cold pressed black oil |
| | meal (prepared by pressing | sunflower seed meal |
| | between about 30-35° C.) | |
| c | 0.152 | 0.64 |
| d | 10 | 20 |
| e | 64.59 | 86.45 |
| f | 2.26 | 1.42 |
| g | 14.5 | 7.78 |
| h | 2.02 | 1.29 |
| i | 245 | 230 |
| j | 15.52 | 12.94 |
| k | 8.94 | 7.82 |
| l | 240 | 220 |
| m | 1.97 | 1.11 |
| n | 7.15 | 7.09 |
| o | 240 | 220 |
| p | 50 | about 40 |
| q | 48 | 50 |
| r | 6.63 | 5.73 |
| s | 250 | 200 |
| t | 6.15 | 3.89 |
| u | 10.68 | 5.31 |
| v | 7.01 | 6.94 |
| w | 34.72 | 38.56 |
| x | 73 | 72 |
| y | 34.04 | 38.40 |
| z | 95.04 | 83.42 |
| ab | 4.13 | 4.41 |
| ac | 19.90 | 22.01 |
| ad | 20.75 | 20.04 |
| ae | 21.78 | 23.15 |
| af | 14.5 | 7.78 |
| ag | 4.53 | 4.74 |
| ah | 7.99 | 9.81 |
| ai | 56.70 | 48.32 |
| aj | 72.5 | about 31.1 |
| ak | RO | City |
| al | 50 | 53 |
| am | 4.08 | 4.88 |
| an | about 70 | about 30 |
| ao | 16 | not recorded |
| ap | 67.09 | 59.51 |

### Example 4

30 kg of cold pressed black oil sunflower seed meal was combined with 300 L of reverse osmosis purified (RO) water having a temperature of 63.7° C., 0.15 kg of ascorbic acid and 0.70 kg of 25% NaOH solution. The mixture was stirred for 20 minutes. A portion of the suspended residual solids (99.08 kg) were removed by centrifugation using a decanter centrifuge to provide a protein solution having a protein content of 1.60 wt % and a pH of 7.25. The protein solution was then further clarified by centrifugation using a disc stack centrifuge to remove additional suspended (finer) residual solids (8.0 kg) and provide a protein solution having a protein content of 1.19 wt %. 224 L of this protein solution was then fed to a three-phase separator which removed 13.88 kg of oil phase and another 8.32 kg of suspended solids and provided 210 L of protein solution having a protein content of 1.21 wt %. This solution had a pH of 7.11.

The protein solution was then reduced in volume from 210 L to 40 L by concentration on a polyethersulfone membrane having a pore size of 100,000 daltons, operated at a temperature of about 46° C. The protein solution, with a protein content of 4.59 wt %, was then diafiltered on the same membrane with 200 L of RO water, with the diafiltration operation conducted at about 52° C. The diafiltered protein solution, having a protein content of 3.69 wt % was then further concentrated to a protein content of 5.14 wt %. This diafiltered and concentrated protein solution had a pH of 7.06. 37.1 kg of diafiltered and concentrated protein solution was pasteurized at about 72° C. for 1 minute. 36.7 kg of pasteurized solution was spray dried to yield a product having a protein content of 78.82% (N×6.25) d.b. The product was termed SF08-K04-21A SF870N.

The residual solids collected in the decanter centrifugation step had a protein content of 4.54 wt % and a solids content of 17.85 wt % (25.43% protein (N×6.25) d.b.). A sample of these residual solids was freeze dried to provide a product having an as-is protein content of 24.51 wt %, termed SF08-K04-21A SM.

8.0 kg of finer residual solids from the disc stack centrifugation step, having a protein content of 6.52 wt % and a solids content of 13.77 wt % (47.35% protein (N×6.25) d.b.), was combined with 32 L of RO water having a temperature of 50° C. The mixture was centrifuged with a disc stack centrifuge and 3.6 kg of washed finer solids and 35 L of used wash solution was collected. The washed finer solids were pasteurized at about 72° C. for 16 seconds. The pasteurized material had a protein content of 6.82 wt % and a solids content of 18.15% (37.58% protein (N×6.25) d.b.) was spray dried to form a product termed SF08-K04-21A SF870PN.

Note all cited pH values were from measurements conducted with the sample at room temperature unless otherwise noted. The extraction slurry was noted as having a pH of 7.1 when measured at 62.1° C. Protein determinations were by combustion analysis using a conversion factor of 6.25.

### Example 5

30 kg of partially defatted sunflower kernel flour was combined with 300 L of reverse osmosis purified (RO) water having a temperature of 60.9° C., 0.15 kg of ascorbic acid and 25% NaOH solution to adjust the pH of the mixture. Another 30 kg of partially defatted sunflower kernel flour was combined with 300 L of reverse osmosis purified (RO) water having a temperature of 58.9° C., 0.15 kg of ascorbic acid and 25% NaOH solution to adjust the pH of the mixture. In total 1.36 kg of 25% NaOH solution was used. The mixtures were stirred for 10 minutes. A portion of the suspended residual solids (195.94 kg) were removed by centrifugation using a decanter centrifuge to provide a protein solution having a protein content of 3.41 wt % and a pH of 7.72. The protein solution was then further clarified by centrifugation using a disc stack centrifuge to remove additional suspended (finer) residual solids (19.80 kg) and provide a protein solution having a protein content of 3.01 wt %. This protein solution was then fed to a three-phase separator which removed 31.58 kg of oil phase and another 19.94 kg of suspended solids and provided 390 L of protein solution having a protein content of 2.87 wt %. This solution had a pH of 7.53.

The protein solution was then reduced in volume from 390 L to 150 L by concentration on a polyethersulfone membrane having a pore size of 10,000 daltons, operated at a temperature of about 49° C. The protein solution, with a protein content of 7.16 wt %, was then diafiltered on the same membrane with 600 L of RO water, with the diafiltration operation conducted at about 52° C. The diafiltered protein solution, having a protein content of 7.06 wt % was then further concentrated to a protein content of 14.02 wt %. This diafiltered and concentrated protein solution had a pH of 6.87. 70.94 kg of diafiltered and concentrated protein solution was pasteurized at about 75° C. for about 16 seconds. 42.81 kg of the pasteurized solution was spray dried to yield a product having a protein content of 96.13% (N×6.25) d.b. The product was termed SF11-K25-21A SF870N.

The residual solids collected in the decanter centrifugation step had a protein content of 5.60 wt % and a solids content of 15.14 wt % (36.99% protein (N×6.25) d.b.). A sample of these residual solids was freeze dried to provide a product having an as-is protein content of 42.82 wt %, termed SF11-K25-21A SM.

A small sample of the finer residual solids from the disc stack centrifugation step, having a protein content of 10.66 wt % and a solids content of 18.21 wt % (58.54% protein (N×6.25) d.b.), was freeze dried to provide a product having an as-is protein content of 58.63%. The product was termed SF11-K25-21A SF870PN-01. Another small sample of the finer residual solids from the disc stack centrifugation step was mixed with 4 volumes of RO water and the washed finer solids recovered using a lab centrifuge. The washed finer solids were freeze dried to provide a product having an as-is protein content of 48.01%. The product was termed SF11-K25-21A SF870PN-02.

Note all cited pH values were from measurements conducted with the sample at room temperature unless otherwise noted. One of the extraction slurries was noted as having a pH of 7.20 when measured at 48° C. and the other 7.19 when measured at 50.9° C. Protein determinations were by combustion analysis using a conversion factor of 6.25.

### Example 6

30 kg of partially defatted sunflower kernel flour was combined with 300 L of reverse osmosis purified (RO) water having a temperature of 63.6° C., 0.15 kg of ascorbic acid and 0.80 kg of 25% NaOH solution. The mixture was stirred for 10 minutes. A portion of the suspended residual solids (98.97 kg) were removed by centrifugation using a decanter centrifuge to provide a protein solution having a protein content of 3.62 wt % and a pH of 7.64. The protein solution was then further clarified by centrifugation using a disc stack centrifuge to remove additional suspended (finer) residual solids (8.40 kg) and provide a protein solution having a protein content of 3.16 wt %. This protein solution was then fed to a three-phase separator which removed 18.56 kg of oil phase and another 9.62 kg of suspended solids and provided 165 L of protein solution having a protein content of 3.07 wt %. This solution had a pH of 7.54.

The protein solution was then reduced in volume from 165 L to 65 L by concentration on a polyethersulfone membrane having a pore size of 10,000 daltons, operated at a temperature of about 50° C. The protein solution, with a protein content of 7.00 wt %, was then diafiltered on the same membrane with 325 L of RO water, with the diafiltration operation conducted at about 53° C. The diafiltered protein solution, having a protein content of 6.35 wt % was then further concentrated to a protein content of 11.43 wt %. This diafiltered and concentrated protein solution had a pH of 7.15. 37.98 kg of diafiltered and concentrated protein solution was pasteurized at about 72° C. for 16 seconds. 37.44 kg of pasteurized solution was spray dried to yield a product having a protein content of 97.00% (N×6.25) d.b. The product was termed SF11-L01-21A SF870N.

The residual solids collected in the decanter centrifugation step had a protein content of 6.55 wt % and a solids content of 14.63 wt % (44.77% protein (N×6.25) d.b.). A sample of these residual solids was freeze dried to provide a product having an as-is protein content of 42.90 wt %, termed SF11-L01-21A SM.

A small sample of the finer residual solids from the disc stack centrifugation step, having a protein content of 11.42 wt % and a solids content of 19.28 wt % (59.23% protein (N×6.25) d.b.), was freeze dried to provide a product having an as-is protein content of 56.75%. The product was termed SF11-L01-21A SF870PN-01. Another small sample of the finer residual solids from the disc stack centrifugation step was mixed with 4 volumes of RO water and the washed finer solids recovered using a lab centrifuge. The washed finer solids were freeze dried to provide a product having an as-is protein content of 43.62%. The product was termed SF11-L01-21A SF870PN-02.

Note all cited pH values were from measurements conducted with the sample at room temperature unless otherwise noted. The extraction slurry was noted as having a pH of 7.11 at 60.8° C. Protein determinations were by combustion analysis using a conversion factor of 6.25.

### Example 7

30 kg of partially defatted sunflower kernel flour was combined with 300 L of reverse osmosis purified (RO) water having a temperature of 60.1° C., 0.30 kg of ascorbic acid and 0.72 kg of 25% NaOH solution. The pH of the slurry was 7.27. The mixture was stirred for 10 minutes. A portion of the suspended residual solids (95.20 kg) were removed by centrifugation using a decanter centrifuge to provide a protein solution having a protein content of 3.32 wt % and a pH of 7.13. The protein solution was then further clarified by centrifugation using a disc stack centrifuge to remove additional suspended (finer) residual solids (19.48 kg) and provide a protein solution having a protein content of 2.55 wt %. 200 L of protein solution was then fed to a three-phase separator which removed 22.72 kg of oil phase and another 17.60 kg of suspended solids and provided 175 L of protein solution having a protein content of 2.34 wt %. This solution had a pH of 7.07.

The protein solution was then reduced in volume from 175 L to 50 L by concentration on a polyethersulfone membrane having a pore size of 10,000 daltons, operated at a temperature of about 41° C. The protein solution, with a protein content of 6.31 wt %, was then diafiltered on the same membrane with 270 L of RO water, with the diafiltration operation conducted at about 49° C. The diafiltered protein solution, having a protein content of 5.63 wt % was then further concentrated to a protein content of 10.34 wt %. This diafiltered and concentrated protein solution had a pH of 6.89. The diafiltered and concentrated protein solution was pasteurized at about 72° C. for 16 seconds. 28.52 kg of pasteurized solution was spray dried to yield a product having a protein content of 95.04% (N×6.25) d.b. The product was termed SF11-L16-21A SF870N.

The residual solids collected in the decanter centrifugation step had a protein content of 7.20 wt % and a solids content of 15.53 wt % (46.36% protein (N×6.25) d.b.).

Note all cited pH values were from measurements conducted with the sample at room temperature unless otherwise noted. Protein determinations were by combustion analysis using a conversion factor of 6.25.

### Example 8

30 kg of partially defatted sunflower kernel flour was combined with 300 L of reverse osmosis purified (RO) water having a temperature of 62.6° C., 0.45 kg of ascorbic acid and 0.96 kg of 25% NaOH solution. The mixture was stirred for 10 minutes. A portion of the suspended residual solids (99.95 kg) were removed by centrifugation using a decanter centrifuge to provide a protein solution having a protein content of 3.50 wt % and a pH of 7.55. The protein solution was then further clarified by centrifugation using a disc stack centrifuge to remove additional suspended (finer) residual solids (11.18 kg) and provide a protein solution having a protein content of 2.93 wt %. 230 L of protein solution was then fed to a three-phase separator which removed 23.62 kg of oil phase and another 9.60 kg of suspended solids and provided 160 L of protein solution having a protein content of 2.80 wt %. This solution had a pH of 7.37.

The protein solution was then reduced in volume from 160 L to 60 L by concentration on a polyethersulfone membrane having a pore size of 10,000 daltons, operated at a temperature of about 46° C. The protein solution, with a protein content of 6.36 wt %, was then diafiltered on the same membrane with 300 L of RO water, with the diafiltration operation conducted at about 51° C. The diafiltered protein solution, having a protein content of 6.45 wt % was then further concentrated to a protein content of 11.19 wt %. This diafiltered and concentrated protein solution had a pH of 7.15. The diafiltered and concentrated protein solution was pasteurized at about 72° C. for about 1 minute. 32.66 kg of pasteurized solution was spray dried to yield a product having a protein content of 97.70% (N×6.25) d.b. The product was termed SF11-A12-22A SF870N.

The residual solids collected in the decanter centrifugation step had a protein content of 6.94 wt % and a solids content of 14.97 wt % (46.36% protein (N×6.25) d.b.). A sample of these residual solids was freeze dried to provide a product having an as-is protein content of 44.26 wt %, termed SF11-A12-22A SM.

The finer residual solids from the disc stack centrifugation step, having a protein content of 9.99 wt %, was pasteurized at about 72° C. for 16 seconds. The pasteurized material was diluted with RO water and spray dried to provide a product with a protein content of 65.64% (N×6.25) d.b. termed SF11-A12-22A SF870PN.

Note all cited pH values were from measurements conducted with the sample at room temperature unless otherwise noted. Protein determinations were by combustion analysis using a conversion factor of 6.25.

### Example 9

30 kg of sunflower cake/meal (prepared by pressing black oil sunflower kernels) was combined with 300 L of reverse osmosis purified (RO) water having a temperature of 61.1° C., 0.45 kg of ascorbic acid and 0.66 kg of 25% NaOH solution. The mixture was stirred for 15 minutes. A portion of the suspended residual solids (79.68 kg) were removed by centrifugation using a decanter centrifuge to provide a protein solution having a protein content of 2.60 wt % and a pH of 7.18. The protein solution was then further clarified by centrifugation using a disc stack centrifuge to remove additional suspended (finer) residual solids (17.10 kg) and provide a protein solution having a protein content of 2.32 wt %. 240 L of protein solution was then fed to a three-phase separator which removed 26.68 kg of oil phase and another 9.76 kg of suspended solids and provided 180 L of protein solution having a protein content of 2.10 wt %. This solution had a pH of 6.98.

The protein solution was then reduced in volume from 180 L to 50 L by concentration on a polyethersulfone membrane having a pore size of 10,000 daltons, operated at a temperature of about 49° C. The protein solution, with a protein content of 6.24 wt %, was then diafiltered on the same membrane with 250 L of RO water, with the diafiltration operation conducted at about 52° C. The diafiltered protein solution, having a protein content of 7.77 wt % was then further concentrated to a protein content of 10.74 wt %. This diafiltered and concentrated protein solution had a pH of 6.83. The diafiltered and concentrated protein solution was pasteurized at about 72° C. for about 1 minute. 27.94 kg of pasteurized solution was spray dried to yield a product having a protein content of 103.83% (N×6.25) d.b. The product was termed SF12-A13-22A SF870N.

The residual solids collected in the decanter centrifugation step had a protein content of 6.65 wt % and a solids content of 19.24 wt % (34.56% protein (N×6.25) d.b.). A sample of these residual solids was freeze dried to provide a product having an as-is protein content of 35.17 wt %, termed SF12-A13-22A SM.

An aliquot of the finer residual solids from the disc stack centrifugation step, having a protein content of 5.45 wt %, was pasteurized. The pasteurized finer solids had a protein content of 5.59 wt % and a solids content of 10.70% (52.24% protein (N×6.25) d.b.). The pasteurized material spray dried to provide a product termed SF12-A13-22A SF870PN.

Note all cited pH values were from measurements conducted with the sample at room temperature unless otherwise noted. Protein determinations were by combustion analysis using a conversion factor of 6.25.

### Example 10

30 kg of partially defatted sunflower kernel flour was combined with 300 L of reverse osmosis purified (RO) water having a temperature of 59.6° C., 0.45 kg of ascorbic acid and 0.78 kg of 25% NaOH solution. The mixture was stirred for 10 minutes. A portion of the suspended residual solids (102.94 kg) were removed by centrifugation using a decanter centrifuge to provide a protein solution having a protein content of 2.99 wt % and a pH of 7.38. The protein solution was then further clarified by centrifugation using a disc stack centrifuge to remove additional suspended (finer) residual solids (18.94 kg) and provide a protein solution having a protein content of 2.52 wt %. 200 L of protein solution was then fed to a three-phase separator which removed 12.86 kg of oil phase and another 17.80 kg of suspended solids and provided 185 L of protein solution having a protein content of 2.37 wt %. This solution had a pH of 7.10.

The protein solution was then reduced in volume from 185 L to 50 L by concentration on a polyethersulfone membrane having a pore size of 10,000 daltons, operated at a temperature of about 50° C. The protein solution, with a protein content of 7.88 wt %, was then diafiltered on the same membrane with 250 L of RO water, with the diafiltration operation conducted at about 52° C. The diafiltered protein solution, having a protein content of 7.53 wt % was then further concentrated to a protein content of 10.85 wt %. This diafiltered and concentrated protein solution had a pH of 7.01. 31.50 kg of diafiltered and concentrated protein solution was pasteurized at about 72° C. for 16 seconds. 31.50 kg of pasteurized solution was spray dried to yield a product having a protein content of 96.30% (N×6.25) d.b. The product was termed SF11-A17-22A SF870N.

9.32 kg of the residual solids collected in the decanter centrifugation step was diluted with 9.32 kg of water and spray dried to provide a product having a protein content of 44.76% (N×6.25) d.b. The product was termed SF11-A17-22A SM.

18.94 kg of finer residual solids from the disc stack centrifugation step, having a protein content of 8.24 wt %, was pasteurized at about 72° C. for 1 minute. The pasteurized finer solids had a protein content of 8.26 wt % and a solids content of 14.35% (57.56% protein (N×6.25) d.b.). The pasteurized material was spray dried to provide a product termed SF11-A17-22A SF870PN.

Note all cited pH values were from measurements conducted with the sample at room temperature unless otherwise noted. The extraction slurry was noted as having a pH of 7.09 at 55.5° C. Protein determinations were by combustion analysis using a conversion factor of 6.25.

### Example 11

30 kg of cold pressed black oil sunflower seed meal was combined with 300 L of reverse osmosis purified (RO) water having a temperature of 61.2° C., 0.30 kg of ascorbic acid and 1.10 kg of 25% NaOH solution. The mixture was stirred for an unrecorded length of time. A portion of the suspended residual solids (91.30 kg) were removed by centrifugation using a decanter centrifuge to provide a protein solution having a protein content of 1.56 wt % and a pH of 7.48. The protein solution was then further clarified by centrifugation using a disc stack centrifuge to remove additional suspended (finer) residual solids (7.58 kg) and provide a protein solution having a protein content of 1.27 wt %. 250 L of protein solution was then fed to a three-phase separator which removed 13.52 kg of oil phase and another 9.08 kg of suspended solids and provided 140 L of protein solution having a protein content of 1.28 wt %. This solution had a pH of 7.23.

The protein solution was then reduced in volume from 140 L to 40 L by concentration on a polyethersulfone membrane having a pore size of 10,000 daltons, operated at a temperature of about 51° C. The protein solution, with a protein content of 3.72 wt %, was then diafiltered on the same membrane with 200 L of RO water, with the diafiltration operation conducted at about 51° C. The diafiltered protein solution, having a protein content of 2.48 wt % was then further concentrated to a protein content of 5.32 wt %. This diafiltered and concentrated protein solution had a pH of 6.99. 24.26 kg of diafiltered and concentrated protein solution was pasteurized at about 72° C. for about 6 minutes. 24.14 kg of pasteurized solution was spray dried to yield a product having a protein content of 80.85% (N×6.25) d.b. The product was termed SF08-B28-22A SF870N.

The residual solids collected in the decanter centrifugation step had a protein content of 4.67 wt % and a solids content of 21.71 wt % (21.51% protein (N×6.25) d.b.).

The finer residual solids from the disc stack centrifugation step, had a protein content of 5.97 wt %, and a solids content of 12.46% (47.91% protein (N×6.25) d.b.).

Note all cited pH values were from measurements conducted with the sample at room temperature unless otherwise noted. The extraction slurry was noted as having a pH of 7.10 at 59.6° C. Protein determinations were by combustion analysis using a conversion factor of 6.25.

### Example 12

Commercial solvent processed sunflower meal was ground and then 14 kg of the ground meal combined with 140 L of reverse osmosis purified (RO) water having a temperature of 60° C., 0.14 kg of ascorbic acid and 0.28 kg of 25% NaOH solution. The mixture was stirred for 15 minutes. A portion of the suspended residual solids (28.24 kg) were removed by centrifugation using a decanter centrifuge to provide a protein solution having a protein content of 1.22 wt % and a pH of 7.00. The protein solution was then further clarified by centrifugation using a disc stack centrifuge to remove additional suspended (finer) residual solids (3.80 kg) and provide a protein solution having a protein content of 1.09 wt %. This solution had a pH of 6.96.

The protein solution was then reduced in volume from 105 L to 40 L by concentration on a polyethersulfone membrane having a pore size of 10,000 daltons, operated at a temperature of about 50° C. The protein solution, with a protein content of 2.32 wt %, was then diafiltered on the same membrane with 200 L of RO water, with the diafiltration operation conducted at about 50° C. The diafiltered protein solution, having a protein content of 2.04 wt % was then further concentrated to a protein content of 3.21 wt %. This diafiltered and concentrated protein solution had a pH of 6.90. 28.66 kg of diafiltered and concentrated protein solution was pasteurized at about 72° C. for 16 seconds. 27.74 kg of pasteurized solution was spray dried to yield a product having a protein content of 86.64% (N×6.25) d.b. The product was termed SF13-C07-22A SF870N.

The residual solids collected in the decanter centrifugation step had a protein content of 8.92 wt % and a solids content of 25.53 wt % (34.94% protein (N×6.25) d.b.).

The finer residual solids from the disc stack centrifugation step, had a protein content of 2.57 wt %, and a solids content of 4.91% (52.34% protein (N×6.25) d.b.).

Note all cited pH values were from measurements conducted with the sample at room temperature unless otherwise noted. The extraction slurry was noted as having a pH of 7.15 at 56.7° C. Protein determinations were by combustion analysis using a conversion factor of 6.25.

### Example 13

This Example describes preparation of the product of the invention with initial extraction steps simulating counter current extraction.

30 kg of partially defatted sunflower flour was combined with 300 L of reverse osmosis purified (RO) water having a temperature of 60.5° C., 0.45 kg of ascorbic acid and 0.86 kg of 25% NaOH solution. The mixture was stirred for 10 minutes. A portion of the suspended residual solids, termed spent meal 1 (53.00 kg) were removed by centrifugation using a decanter centrifuge to provide a protein solution, termed extract 1, having a protein content of 2.96 wt % and a pH of 7.06. Spent meal 1 had an as-is protein content of 9.78 wt % and a solids content of 21.80 wt % (44.86% protein (N×6.25) d.b.).

53.00 kg of spent meal 1 was combined with 300 L of reverse osmosis purified (RO) water having a temperature of 58.7° C. and the mixture stirred for 10 minutes. A portion of the residual suspended solids, termed spent meal 2 (47.53 kg) were removed by centrifugation using a decanter centrifuge to provide a protein solution termed extract 2, having a protein content of 0.92 wt % and a pH of 7.40. Spent meal 2 had an as-is protein content of 5.84 wt % and a solids content of 16.44 wt % (35.52% protein (N×6.25) d.b.). A sample of spent meal 2 was freeze dried to provide a product having an as-is protein content of 35.69 wt %, termed SF11-A20-22A SM2.

28.5 kg of partially defatted sunflower flour was combined with 285 L of extract 2 having a temperature of about 50° C., 0.45 kg of ascorbic acid and 0.80 kg of 25% NaOH solution. The mixture was stirred for 10 minutes. A portion of the residual suspended solids, termed spent meal 3 (51.63 kg) were removed by centrifugation using a decanter centrifuge to provide a protein solution, termed extract 3, having a protein content of 3.94 wt % and a pH of 7.27. This protein solution was then further clarified by centrifugation using a disc stack centrifuge to remove additional suspended (finer) residual solids (21.46 kg) and provide a protein solution having a protein content of 3.16 wt %. This solution had a pH of 7.17. This protein solution was then fed to a three-phase separator which removed 19.22 kg of oil phase and another 28.78 kg of suspended solids and provided 190 L of protein solution having a protein content of 3.11 wt %. This solution had a pH of 7.11.

The protein solution was then reduced in volume from 190 L to 40 L by concentration on a polyethersulfone membrane having a pore size of 10,000 daltons, operated at a temperature of about 50° C. The protein solution, with a protein content of 12.13 wt %, was then diafiltered on the same membrane with 200 L of RO water, with the diafiltration operation conducted at about 51° C. The diafiltered protein solution, having a protein content of 11.00 wt % was then further concentrated to a protein content of 16.01 wt %. This diafiltered and concentrated protein solution had a pH of 7.07. 27.75 kg of diafiltered and concentrated protein solution was pasteurized at about 72° C. for about 2 minutes. 26.35 kg of pasteurized solution was spray dried to yield a product having a protein content of 95.11% (N×6.25) d.b. The product was termed SF11-A20-22A SF870N.

Spent meal 3 had an as-is protein content of 10.40 wt % and a solids content of 24.45 wt % (42.54% protein (N×6.25) d.b.).

21.46 kg of finer residual solids from the disc stack centrifugation step, having a protein content of 12.09 wt %, were pasteurized at about 72° C. for 16 seconds. The pasteurized material was spray dried to provide a product having a protein content of 62.33% (N×6.25) d.b. termed SF11-A20-22A SF870PN.

Note all cited pH values were from measurements conducted with the sample at room temperature unless otherwise noted. The initial extraction slurry was noted as having a pH of 7.07 at 54.7° C. The second extraction slurry was noted as having a pH of 7.04 at 57.8° C. The third extraction slurry was noted as having a pH of 7.19 at 50° C. Protein determinations were by combustion analysis using a conversion factor of 6.25.

### Example 14

This Example illustrates the protein content of dried sunflower protein products prepared as described in Examples 1 to 13 as well as the commercially available sunflower protein products Sunbloom (Sunbloom Proteins GmbH), Heliaflor 55 (Austrade Inc.) and Sunflower Seed Powder 50% protein (Acetar Bio-Tech Inc.).

As-is protein content was determined by combustion analysis (N×6.25). Dry basis protein contents were calculated from the as-is protein value and the determined dry matter content of the samples. The protein content of the samples is shown in Table 2.

TABLE 2
Protein content of sunflower protein products

| | % protein | % protein |
|---|---|---|
| Product | (N × 6.25), as-is | (N × 6.25), d.b. |
| SF06-G06-21A SF870N | 84.93 | 89.03 |
| SF09-J21-21A SF870N | 93.63 | 98.41 |
| SF10-K01-21A SF870N | 91.14 | 95.04 |
| SF08-K02-21A SF870N | 79.23 | 83.42 |
| SF08-K04-21A SF870N | 74.86 | 78.82 |
| SF11-K25-21A SF870N | 91.77 | 96.13 |
| SF11-L01-21A SF870N | 92.18 | 97.00 |
| SF11-L16-21A SF870N | 90.67 | 95.04 |
| SF11-A12-22A SF870N | 91.09 | 97.70 |
| SF12-A13-22A SF870N | 97.82 | 103.83 |
| SF11-A17-22A SF870N | 91.20 | 96.30 |
| SF08-B28-22A SF870N | 76.27 | 80.85 |
| SF13-C07-22A SF870N | 80.48 | 86.64 |
| SF11-A20-22A SF870N | 89.53 | 95.11 |
| SF09-J21-21A SF870PN-01 | 51.23 | not determined |
| SF10-K01-21A SF870PN | 60.52 | 67.09 |
| SF08-K02-21A SF870PN | 54.67 | 59.51 |
| SF11-K25-21A SF870PN-01 | 58.63 | not determined |
| SF11-K25-21A SF870PN-02 | 48.01 | not determined |
| SF11-L01-21A SF870PN-01 | 56.75 | not determined |
| SF11-L01-21A SF870PN-02 | 43.62 | not determined |
| SF11-A12-22A SF870PN | 59.72 | 65.54 |
| SF11-A20-22A SF870PN | 58.23 | 62.33 |
| SF10-K01-21A SM | 21.78 | not determined |
| SF08-K02-21A SM | 23.15 | not determined |
| SF08-K04-21A SM | 24.51 | not determined |
| SF11-K25-21A SM | 42.82 | not determined |
| SF11-L01-21A SM | 42.90 | not determined |
| SF11-A12-22A SM | 44.26 | not determined |
| SF12-A13-22A SM | 35.17 | not determined |
| SF11-A17-22A SM | 41.61 | 44.76 |
| SF11-A20-22A SM2 | 35.69 | not determined |
| Sunbloom | 50.48 | 53.97 |
| Heliaflor 55 | 51.43 | 55.06 |
| Sunflower Seed | 56.00 | 58.04 |
| Powder 50% Protein | | |

As may be seen from the results in Table 2, the product of the invention derived from the sunflower protein solution (SF870N) was much higher in protein than the commercial product evaluated. The protein content of the product of the invention derived from the finer residual solids (SF870PN) was closer to that of the commercial product evaluated. The product derived from the residual solids captured by the decanter centrifuge was lower in protein content.

### Example 15

This Example illustrates the protein solubility of the sunflower protein products prepared as described in Examples 1 to 13 as well as the commercially available sunflower protein products Sunbloom (Sunbloom Proteins GmbH) and Sunflower Seed Powder 50% protein (Acetar Bio-Tech Inc.).

A 100 ml beaker and magnetic stir bar were pre-weighed. Sufficient protein powder to supply 2 g of protein was weighed into the beaker. 10-15 ml of RO water was added and the sample stirred with the stir bar until the powder was thoroughly wetted. At this point another 25-30 ml of RO water was added and mixed in. The pH of the sample was adjusted to the target value with 0.5M NaOH or HCl as necessary and the sample stirred on a magnetic stir plate set to a speed just below forming a vortex in the sample for about 55-60 minutes with the pH periodically checked and adjusted if necessary during this time. At the end of the stirring time the pH of the sample was checked and corrected as necessary again and then additional RO water added to bring the sample weight to 50 g (protein concentration of 4% w/w) and mixed in. Approximately 20 ml of the dispersion was then transferred to a 50 ml centrifuge tube and centrifuged at 10,000 rpm (7,800 g) in a Sorvall SS-34 rotor for 10 minutes with the centrifuge set to 20° C. After the centrifugation was completed 10 ml of supernatant was removed from the centrifuge tube by pipet. Samples of the supernatant and the original dispersion were tested for protein content by combustion analysis (N×6.25).

Solubility (%)=(supernatant protein conc./original dispersion protein conc.)×100

The protein solubility of the sunflower protein products of Examples 1 to 3 and the commercial product is shown in Table 3.

TABLE 3
Solubility of sunflower protein products at different pH values

| | pH 4 | pH 5.5 | pH 7 |
|---|---|---|---|
| SF06-G06-21A SF870N | 17.7 | 12.5 | 97.7 |
| SF09-J21-21A SF870N | 67.5 | 19.0 | 93.1 |
| SF10-K01-21A SF870N | 65.1 | 19.9 | 91.2 |
| SF06-K02-21A SF870N | 14.2 | 13.3 | 97.8 |
| SF08-K04-21A SF870N | 0.8 | 9.5 | 96.8 |
| SF11-K25-21A SF870N | 60.7 | 11.1 | 64.9 |
| SF11-L01-21A SF870N | 53.3 | 12.2 | 62.8 |
| SF11-L16-21A SF870N | 49.8 | 10.4 | 63.5 |
| SF11-A12-22A SF870N | 46.3 | 11.7 | 60.9 |
| SF12-A13-22A SF870N | 56.3 | 14.9 | 73.5 |
| SF11-A17-22A SF870N | 48.9 | 14.0 | 63.2 |
| SF08-B28-22A SF870N | 7.5 | 10.8 | 97.8 |
| SF13-C07-22A SF870N | 1.0 | 6.6 | 96.0 |
| SF11-A20-22A SF870N | 56.0 | 14.1 | 53.7 |
| SF10-K01-21A SF870PN | 17.6 | 14.7 | 28.9 |
| SF06-K02-21A SF870PN | 12.5 | 9.6 | 36.8 |
| SF11-A12-22A SF870PN | 15.7 | 10.9 | 25.2 |
| SF11-A20-22A SF870PN | 9.5 | 4.9 | 22.4 |
| Sunbloom | 20.4 | 20.7 | 41.4 |
| Sunflower Seed Powder 50% | 15.7 | 12.5 | 13.1 |
| Protein | | | |

As may be seen from the results presented in Table 3, the solubility of the 870N protein product of the invention was higher than the solubility of the commercial product at pH 7.

### Example 16

This Example contains an evaluation of the dry colour of the sunflower protein products prepared as described in Examples 1 to 13 as well as the commercially available sunflower protein product Sunbloom (Sunbloom Proteins GmbH) and Heliaflor 55 (Austrade Inc.). Dry colour (CIEL*a*b*) was assessed using a HunterLab ColorQuest XE instrument operated in reflectance mode (RSEX) with an illuminant setting of D65 and an observer setting of 10°. The results are shown in the following Table 4.

TABLE 4
Dry colour of sunflower protein products

| Product | L* | a* | b* |
|---|---|---|---|
| SF06-G06-21A SF870N | 51.97 | 3.09 | 18.93 |
| SF09-J21-21A SF870N | 79.73 | 0.04 | 11.00 |
| SF10-K01-21A SF870N | 76.95 | 0.29 | 12.65 |
| SF06-K02-21A SF870N | 50.06 | 4.83 | 20.14 |
| SF08-K04-21A SF870N | 47.35 | 4.75 | 19.19 |
| SF11-K25-21A SF870N | 66.02 | 1.90 | 14.02 |
| SF11-L01-21A SF870N | 72.75 | 1.45 | 13.59 |
| SF11-L16-21A SF870N | 70.93 | 1.54 | 14.29 |
| SF11-A12-22A SF870N | 72.52 | 1.19 | 13.62 |
| SF12-A13-22A SF870N | 76.88 | 0.69 | 14.35 |
| SF11-A17-22A SF870N | 70.53 | 1.55 | 13.35 |
| SF08-B28-22A SF870N | 46.68 | 5.16 | 19.83 |
| SF13-C07-22A SF870N | 62.11 | 3.56 | 20.04 |
| SF11-A20-22A SF870N | 69.75 | 1.80 | 14.54 |
| SF10-K01-21A SF870PN | 75.44 | 1.09 | 13.67 |
| SF06-K02-21A SF870PN | 49.51 | 4.61 | 18.73 |
| SF11-A12-22A SF870PN | 72.60 | 1.03 | 14.54 |
| SF11-A20-22A SF870PN | 73.50 | 0.91 | 15.42 |
| SF11-A17-22A SM | 74.60 | 1.63 | 15.00 |
| Sunbloom | 79.89 | 0.19 | 9.15 |
| Heliaflor 55 | 78.96 | −0.20 | 9.78 |

As may be seen from the results of Table 4, product of the invention prepared from dehulled kernel meal had a colour that was lighter, greener and bluer than product prepared from black oil seed meal that contained hull material. The colour of the product prepared from dehulled kernel meal was closer to that of the commercial product evaluated (which is also prepared from dehulled kernel meal), but was slightly darker, redder and yellower.

### Example 17

This Example contains an evaluation of the water binding capacity of the sunflower protein products prepared as described in Examples 1-3 and 8-12 as well as the commercially available sunflower protein product Sunbloom (Sunbloom Proteins GmbH) and Heliaflor 55 (Austrade Inc.).

The water binding capacity of the products was determined by the following procedure. Protein powder (1 g) was weighed into centrifuge tubes (50 ml) of known weight. To this powder was added approximately 20 ml of RO water at the natural pH. The contents of the tubes were mixed using a vortex mixer at moderate speed for 1 minute. The samples were incubated at room temperature for 5 minutes then mixed with the vortex for 30 seconds. This was followed by incubation at room temperature for another 5 minutes then another 30 seconds of vortex mixing. The samples were then centrifuged at 1,000 g for 15 minutes at 20° C. After centrifugation, the supernatant was carefully poured off, ensuring that all solid material remained in the tube. The centrifuge tube was then re-weighed and the weight of water saturated sample was determined.

Water binding capacity (WBC) was calculated as:

WBC (ml/g)=(mass of water saturated sample (g)−mass of initial sample (g))/(mass of initial sample (g)×total solids content of sample)

The WBC results are shown in Table 5.

TABLE 5
WBC of sunflower protein products

| Product | WBC (ml/g) |
|---|---|
| SF06-G06-21A SF870N | 2.26 |
| SF09-J21-21A SF870N | 0.83 |
| SF10-K01-21A SF870N | 1.60 |
| SF06-K02-21A SF870N | 2.29 |
| SF11-A12-22A SF870N | 0.66 |
| SF12-A13-22A SF870N | 0.70 |
| SF08-B28-22A SF870N | 2.51 |
| SF13-C07-22A SF870N | 0.52 |
| SF10-K01-21A SF870PN | 2.37 |
| SF06-K02-21A SF870PN | 2.39 |
| SF11-A12-22A SF870PN | 1.66 |
| SF11-A17-22A SM | 6.82 |
| Sunbloom | 3.10 |
| Heliaflor 55 | 3.68 |

As may be seen from the results in Table 5, the products of the invention had a lower water binding capacity than the commercial product other than the product derived from the residual solids captured by the decanter centrifuge, which had high water binding.

### Example 18

This Example contains an evaluation of the oil binding capacity of the sunflower protein product prepared as described in Examples 1 and 8-12 as well as the commercially available sunflower protein product Sunbloom (Sunbloom Proteins GmbH) and Heliaflor 55 (Austrade Inc.).

The oil binding capacity of the products was determined by the following procedure. Protein powder (1 g) was weighed into centrifuge tubes (50 ml) of known weight. To this powder was added approximately 20 ml of retail canola oil. The contents of the tubes were mixed using a vortex mixer at moderate speed for 1 minute. The samples were incubated at room temperature for 5 minutes then mixed with the vortex for 30 seconds. This was followed by incubation at room temperature for another 5 minutes then another 30 seconds of vortex mixing. The samples were then centrifuged at 1,000 g for 15 minutes at 20° C. After centrifugation, the supernatant was pipetted off, ensuring that all solid material remained in the tube. The centrifuge tube was then re-weighed and the weight of oil saturated sample was determined.

Oil binding capacity (OBC) was calculated as:

OBC (ml/g)=((mass of oil saturated sample (g)−mass of initial sample (g))/0.914 g/ml)/(mass of initial sample (g)×total solids content of sample).

The OBC results are shown in Table 6.

TABLE 6
OBC of sunflower protein products

| Product | OBC (ml/g) |
|---|---|
| SF06-G06-21A SF870N | 1.60 |
| SF11-A12-22A SF870N | 1.40 |
| SF12-A13-22A SF870N | 1.16 |
| SF08-B28-22A SF870N | 1.49 |
| SF13-C07-22A SF870N | 1.63 |
| SF11-A12-22A SF870PN | 1.35 |
| SF11-A17-22A SM | 3.04 |
| Sunbloom | 1.79 |
| Heliaflor 55 | 1.35 |

As may be seen from the results in Table 6, the SF870N products had similar oil binding capacities to the commercial products but the product derived from the residual solids captured by the decanter centrifuge had higher oil binding.

### Example 19

This Example contains an evaluation of the phytic acid content of the sunflower protein products prepared as described in Examples 1 and 6 as well as the commercially available sunflower protein products Sunbloom (Sunbloom Proteins GmbH), Heliaflor 55 (Austrade Inc.) and Sunflower Seed Powder 50% protein (Acetar Bio-Tech Inc.). Phytic acid content was determined using the method of Latta and Eskin (J. Agric. Food Chem., 28:1313-1315). The results are shown in Table 7.

TABLE 7
Phytic acid content of sunflower protein products

| Product | % phytic acid (d.b.) |
|---|---|
| SF06-G06-21A SF870N | 0.97 |
| SF11-L01-21A SF870N | 0.82 |
| Sunbloom | 5.60 |
| Heliaflor 55 | 5.75 |
| Sunflower Seed Powder 50% Protein | 3.51 |

As may be seen from the results presented in Table 7, the phytic acid content of the products of the invention was lower than that of the commercial sunflower protein products evaluated.

### Example 20

This Example describes the Amino Acid profile of the sunflower protein products prepared as described in Example 1.

Amino acid profile of the sunflower protein product was assessed experimentally according to method reference USDA MSS2 (1993) by Merieux NutriSciences (Crete, IL). A complete amino acid profile analysis was done, to quantify tryptophan, cysteine/methionine and the remaining amino acids.

The amino acid profile for the sunflower protein products prepared as described in Examples 1, 7, 9 and 10 are shown in Table 8.

TABLE 8
Amino acid profile of protein products

| | concentration (mg/g protein) | | | |
|---|---|---|---|---|
| | SF06-G06- | SF11-L16- | SF12-A13- | SF11-A17- |
| amino acid | 21A SF870N | 21A SF870N | 22A SF870N | 22A SM |
| Aspartic | 100.3 | 110.1 | 111.0 | 146.6 |
| Threonine | 36.6 | 42.0 | 40.7 | 48.9 |
| Serine | 42.4 | 50.9 | 50.8 | 49.3 |
| Glutamic | 225.0 | 127.5 | 128.5 | 143.9 |
| Proline | 47.9 | 59.9 | 59.9 | 56.7 |
| Glycine | 52.2 | 55.6 | 54.7 | 70.4 |
| Alanine | 44.5 | 48.4 | 48.3 | 47.5 |
| Valine | 44.9 | 51.7 | 51.4 | 59.6 |
| Isoleucine | 40.3 | 45.4 | 45.8 | 47.1 |
| Leucine | 63.5 | 71.5 | 71.0 | 89.0 |
| Tyrosine | 27.9 | 33.9 | 33.4 | 27.6 |
| Phenylalanine | 51.8 | 57.8 | 59.0 | 47.1 |
| Lysine | 37.2 | 36.5 | 35.4 | 41.2 |
| Histidine | 27.5 | 30.8 | 30.9 | 25.8 |
| Arginine | 96.7 | 108.0 | 107.9 | 80.2 |
| Cysteine | 24.9 | 23.9 | 23.8 | 16.6 |
| Methionine | 26.8 | 31.7 | 31.2 | 19.3 |
| Tryptophan | 12.9 | 10.9 | 12.1 | 10.8 |

As may be seen from the results presented in Table 8, the SF870N product of the invention evaluated had a particularly high content of sulfur containing amino acids.

### Example 21

This Example illustrates the chlorogenic acid content of the sunflower protein products prepared by the procedures of Examples 1, 5, 7, 8 and 12 and the commercial product Heliaflor 55 (Austrade Inc.). The chlorogenic acid content was determined by modified AOAC 2018.08 by Vanguard Laboratory (Olympia, WA).

TABLE 9
Chlorogenic acid content of sunflower protein products

| Product | Chlorogenic acid content (ppm d.b.) |
|---|---|
| SF06-G06-21A SF870N | 319 |
| SF11-K25-21A SF870N | 353 |
| SF11-L16-21A SF870N | 565 |
| SF11-A12-22A SF870N | 520 |
| SF13-C07-22A SF870N | 179 |
| SF11-A12-22A SF870PN | 9,518 |
| Heliaflor 55 | 21,684 |

As may be seen from the results in Table 9, the products of the invention are much lower in chlorogenic acid than the Heliaflor 55.

### Example 22

This Example illustrates the fat content of the products of the invention prepared as described in Examples 1, 3, 5 and 9-12. The fat content was determined using an acid hydrolysis method (AOAC 933.05) by Merieux NutriSciences (Markham, ON). The results are shown in Table 10.

TABLE 10
Acid hydrolysis fat content of sunflower protein products

| Product | Acid hydrolysis fat content (% d.b.) |
|---|---|
| SF06-G06-21A SF870N | 6.93 |
| SF10-K01-21A SF870N | 9.04 |
| SF11-K25-21A SF870N | 6.62 |
| SF12-A13-22A SF870N | 1.35 |
| SF08-B28-22A SF870N | 11.31 |
| SF13-C07-22A SF870N | 4.72 |
| SF11-A17-22A SM | 11.60 |

As may be seen from the results in Table 10, the SF13-C07-22A made from solvent defatted meal had a level of acid hydrolyzed fat in the range of product made from cold pressed meal.

### Example 23

This Example illustrates the ash content of the products of the invention. The ash content was determined by method AOAC 925.51A by Merieux NutriSciences (Markham, ON). The results are shown in Table 11.

TABLE 11
Ash content of sunflower protein products

| Product | Ash content (% d.b.) |
|---|---|
| SF06-G06-21A SF870N | 2.75 |
| SF11-L01-21A SF870N | 2.62 |

As may be seen from the results in Table 11, the SF810N products tested were low in ash.

### Example 24

This Example illustrates the viscosity in solution of the sunflower protein product prepared as described in Example 3. Solutions of the SF10-K01-21A SF870N were prepared at 10% and 20% protein and the viscosity of the solutions determined at different shear rates using an Anton Paar MCR 302 rheometer fitted with a PP25 plate/plate system. The protein solution sample was placed on the bottom plate and the upper plate was lowered to a 1 mm gap. The viscosity was tested at 25° C. with increasing shear rate from 0.1 to 100 l/s.

Results are as shown in Table 12.

TABLE 12
Viscosity of sunflower protein solutions of SF10-K01-
21A SF870N at different shear rates and concentrations

| Shear rate | Viscosity at 10% protein | Viscosity at 20% protein |
|---|---|---|
| (1/s) | (mPa · s) | (mPa · s) |
| 1.28 | 78.8 | 2162.5 |
| 1.84 | 63.5 | 1636.2 |
| 2.64 | 51.5 | 1249.2 |
| 3.79 | 41.5 | 967.9 |
| 5.46 | 33.8 | 756.0 |
| 7.86 | 28.8 | 599.4 |
| 11.30 | 25.1 | 481.6 |
| 16.30 | 21.8 | 390.7 |
| 23.40 | 19.6 | 320.6 |
| 33.60 | 17.7 | 267.3 |
| 48.40 | 16.3 | 225.0 |
| 69.60 | 15.2 | 191.3 |
| 100.00 | 14.7 | 164.3 |

As may be seen from the results in Table 12, the viscosity of the product decreased with shear rate.

### Example 25

This Example illustrates the emulsifying of the sunflower protein products prepared as described in Examples 1, 2, 3, 7 and 8 as well as the commercial product Sunbloom (Sunbloom Proteins GmbH). Sufficient protein powder to supply 1.5 g of protein was weighed into a 600 ml beaker. RO water was added to make the sample weight up to 150 g. The protein was dispersed using a Silverson L5RT laboratory mixer running at a speed of 4500 rpm. The pH of the dispersion was then measured and adjusted to pH 7 with NaOH or HCl solution as necessary. 150 g of canola oil was added to the dispersion to give a sample that was 0.5% w/w/protein and 50% w/w oil. The mixture was then processed on the Silverson mixer at a speed of 5000 rpm for 5 minutes. A 1.0 g sample of emulsion was weighed into a 100 ml volumetric flask then made up to volume with 0.1% sodium dodecyl sulfate (SDS) solution and mixed thoroughly. 1 ml of this dilution was combined with 4 ml of 0.1% SDS solution to give a 1:500 dilution. The absorbance at 500 nm was then measured for this sample with the spectrophotometer blanked with 0.1% SDS solution. The absorbance value was multiplied by the dilution factor of 500. This value was termed A500. The dilution and absorbance measurement was performed in at least triplicate for each emulsion sample. The higher the A500, the greater the population of small dispersed fat droplets and the better the emulsifying behaviour.

The results of the emulsifying test are presented in Table 13.

TABLE 13
Absorbance readings for emulsions prepared
with sunflower protein products

| Sample | A500 |
|---|---|
| SF06-G06-21A SF870N | 151.5 |
| SF09-J21-21A SF870N | 115.5 |
| Blend of SF10-K01-21A SF870N (61.7%) and | 144.5 |
| SF11-L01-21A SF870N (38.3%) | |
| SF11-L16-21A SF870N | 166.5 |
| Sunbloom | 133.5 |

As may be seen from the results in Table 13, the emulsions prepared with the products of the invention had A500 values similar to the emulsion prepared with the Sunbloom product.

### Example 26

This Example illustrates the preparation and sensory assessment of a dairy alternative beverage with a protein content of about 3.5 wt %, using the sunflower protein products prepared by the procedure of Examples 3 and 6.

The formulation for the sunflower protein dairy alternative beverage is shown in Table 14:

TABLE 14
Formulation for dairy alternative beverage
with sunflower protein product of invention

| Ingredient | Amount (g) | Percentage (%) |
|---|---|---|
| Water, spring | 351.52 | 87.88 |
| SF10-K01-21A SF870N | 9.44 | 2.36 |
| SF11-L01-21A SF870N | 5.84 | 1.46 |
| Sugar, white | 24.00 | 6.00 |
| Sunflower oil | 8.00 | 2.00 |
| Flavour, dry, vanilla | 0.80 | 0.20 |
| Stabilizer, gellan gum | 0.40 | 0.10 |
| Total | 400.00 | 100.00 |

The protein powder, sugar, and stabilizer were placed in a large beaker. The water was added to the dry ingredients and mixed on a magnetic stirring hot plate. When the mixture was dispersed, the oil was slowly added while continually mixing. To batch pasteurize, the product was heated on the magnetic stirring hot plate. When the product reached a temperature between 65° C. and 70° C., the flavour was added. The product was pasteurized at 72-76° C. for 30 seconds. After pasteurization, the product was homogenized using a GEA Niro Soavi Panda Plus at 175 bar/35 bar (210 total). The product was filled into a bottle and stored at refrigerated temperature (4° C.).

The colour of the dairy alternative beverage (CIE L*a*b*) was assessed using a HunterLab ColorQuest XE instrument operated in reflectance mode (RSEX) with an illuminant setting of D65 and an observer setting of 10°. The dairy alternative beverage had the following colour attributes: L*=68.29, a*=1.72, b*=9.97.

The beverage was tasted by an informal sensory panel with 15 participants. Comments provided by the panelists confirmed that an edible beverage of at least acceptable quality was prepared with the product of the invention. Specific comments included “noticeable sunflower taste”, “very good”, “slight seedy flavour”, “slight grainy flavour”, “no off taste”, “too sweet”, “very sweet”, “sunflower notes”, “acceptable”, “pleasant beverage” and “good”.

### Example 27

This Example illustrates the preparation and sensory assessment of chocolate chip oatmeal cookies containing about 3.5 wt % protein from the sunflower protein product prepared by the procedure of Example 8.

The formulation for the cookies is shown in Table 15.

TABLE 15
Formulation for cookies with sunflower
protein product of invention

| Ingredient | Amount (g) | Percentage (%) |
|---|---|---|
| Butter | 111.64 | 13.37 |
| Canola oil | 5.01 | 0.60 |
| Packed brown sugar | 104.38 | 12.50 |
| White sugar | 54.14 | 6.48 |
| SF11-A12-22A SF870N | 32.19 | 3.85 |
| Water, RO | 37.45 | 4.48 |
| Oatmilk | 15.54 | 1.86 |
| Vanilla | 4.68 | 0.56 |
| Flour | 136.1 | 16.30 |
| Baking soda | 2.84 | 0.34 |
| Salt | 1.65 | 0.20 |
| Oats | 132.4 | 15.86 |
| Chocolate chips | 197.01 | 23.59 |
| Total | 835.03 | 99.99 |

The butter, oil, white sugar and brown sugar were placed in a Hobart stand mixer and creamed together. The protein powder and water were manually mixed in a beaker then added to the creamed mixture in the Hobart. The milk and vanilla were then added. The flour, baking soda, salt, and oats were mixed in a bowl then slowly added to the ingredients in the Hobart while mixing on low-medium speed. Once incorporated, the chocolate chips were added either on low speed in the Hobart or mixed in by hand. The cookie batter was dropped by spoonful onto a baking pan and baked at 350° F. for 7-9 min or until slightly golden brown.

The cookies were tasted by an informal sensory panel with 13 participants. Comments provided by the panelists confirmed that an edible cookie of at least acceptable quality was prepared with the product of the invention. Specific comments included “Aroma is mildly chocolate”, “No strong odours”, “Nice aroma”, “No off aroma”, “Typical cookie odour”, “Dry and chewy”, “Crunchy”, “No off taste”, “Delicious flavour”, “Chewy”, “Good mouthfeel”, “Even crumb”, “Chewy texture”, “Nice texture”, “Very good”, “No off flavour”, “Could be more crunchy”, “Good crumb”, “Good crumble”, “Slightly dry”, “No excess oil or fat”, “Tastes like real chocolate chip oatmeal cookie”, “Tastes very sweet (sugary), “Chocolate is dominant”, “Slightly too sweet”, “No noticeable non-cookie attributes”, “Buttery flavour”, “Not that sweet” and “Very good”.

### Example 28

This Example illustrates the preparation and sensory assessment of black bean burgers prepared to contain about 2 wt % protein from the sunflower protein product prepared by the procedure of Example 10. The formulation was derived from the recipe at www.chatelaine.com/recipe/vegetarian/amazing-veggie-burgers with the sunflower protein product used to replace the egg used in the original formulation.

The formulation for the burgers is shown in Table 16.

TABLE 16
Formulation for black bean burgers with
sunflower product of the invention

| Ingredient | Amount (g) | Percentage (%) |
|---|---|---|
| Canned black beans, rinsed, drained | 364.1 | 51.8 |
| Chopped onion | 54.2 | 7.7 |
| Garlic powder | 0.4 | 0.1 |
| Ketchup | 45.0 | 6.4 |
| Worcestershire sauce | 14.9 | 2.1 |
| Canola oil | 10.0 | 1.4 |
| Salt | 3.0 | 0.4 |
| Pepper | 0.9 | 0.1 |
| Flour | 44.3 | 6.3 |
| Breadcrumbs | 60.0 | 8.5 |
| Shredded cheddar cheese | 54.1 | 7.7 |
| Sunflower protein isolate, | 15.1 | 2.1 |
| SF11-A17-22A-SF870N | | |
| Water | 36.7 | 5.2 |
| Total | 878.6 | 100.0 |

The sunflower protein, water and salt were mixed together to disperse and hydrate the protein. The beans were rinsed then drained. The protein blend, beans, onion, oil, ketchup, Worcestershire, salt, and pepper were processed in a Robot Coupe to form a coarse mixture. The contents were transferred to a large bowl and the flour, breadcrumbs, and cheese were manually folded in. The mix was formed into patties and pan fried with oil until lightly browned on each side.

The burger patties were tasted by an informal sensory panel with 4 participants. Comments provided by the panelists confirmed that an edible burger of at least acceptable quality was prepared with the product of the invention. Specific comments included “Smelled quite good”, “Smells of onion and ketchup”, “Good aroma”, “Pasty texture”, “Good crunchy and chewy texture”, “Moist”, “Crisp exterior”, “Pasty interior”, “Crunchy”, “A bit dry”, “Good texture”, “Tasted good”, “Nice spice”, “Peppery flavour”, “Savoury flavour”, “No off flavour”.

### Example 29

This Example illustrates the preparation of mayonnaise type dressing containing 2 wt % protein from the sunflower protein products prepared by the procedures of Examples 3 and 6.

The formulation for the mayonnaise type dressing is shown in Table 17.

TABLE 17
Formulation for mayonnaise type dressing
with sunflower product of the invention

| Ingredient | Amount (g) | Percentage (%) |
|---|---|---|
| Canola oil | 336.00 | 80.00 |
| SF10-K01-21A SF870N | 5.67 | 1.35 |
| SF11-L01-21A SF870N | 3.49 | 0.83 |
| Mustard powder | 2.10 | 0.50 |
| Vinegar (5%) | 25.20 | 6.0 |
| Water | 34.44 | 8.2 |
| Salt | 5.46 | 1.3 |
| Sugar | 8.40 | 2.0 |
| Total | 420.00 | 100.00 |

The protein powder, salt, sugar, and mustard powder were dry blended in a 600 ml beaker. The water and vinegar were added and mixed on a magnetic stir plate until all ingredients were dispersed. 70 ml of canola oil was added to the beaker. The mixing head of a Silverson L5RT fitted with a fine emulsor screen was submerged into the contents of the beaker. The sample was processed at a speed of 5000 rpm while the remainder of the canola oil (266 g) was added as a slow stream via a peristaltic pump. The sample was processed for an additional minute after all the oil was added. The total mixing time was 15-17 minutes.

The mayonnaise type dressing prepared with the product of the invention appeared to be an acceptable edible product based on informal visual and taste assessment.

### Example 30

This Example illustrates the improved gelling behaviour of the product when a moistened air heat treatment was applied to the dried sunflower protein product prepared from the aqueous sunflower protein solution in Example 8.

Small samples of SF11-A12-22A SF870N product were heated in an oven, containing a small open dish of water, under the conditions shown in Table 16. Heat treated powder samples were dispersed in RO water at 10% protein w/w and the mixture heated by placing a vial of material in a 90° C. water bath for 30 minutes. The samples were immediately cooled to room temperature and visual observations about the presence or absence of a gel recorded.

TABLE 18
Heating conditions and results of gelation assessment

| Heating temperature (° C.) | Heating time (hours) | Observation |
|---|---|---|
| N/A | N/A | No gel |
| 100 | 49 | Gelled |
| 130 | 2.5 | Gelled |
| 130 | 10.5 | No gel |
| 140 | 1.5 | Gelled |
| 140 | 2.5 | Gelled |
| 140 | 3.5 | No gel |
| 150 | 0.75 | No gel |

As may be seen from the results in Table 18, certain combinations of heating time and temperature modified the protein product to allow it to gel when heated in solution. With too much temperature modification of the protein product (higher temperature/longer time), it did not gel when heated in solution.

### Example 31

This Example illustrates the sodium content of products prepared as described in Examples 2, 8 and 9.

Sodium contents were determined by an ICP-OES method by Central Testing Laboratory Ltd. (Winnipeg, MB). Results are shown in Table 19 below.

TABLE 19
Sodium content of sunflower protein products

| Product | % sodium (d.b.) |
|---|---|
| SF09-J21-21A SF870N | 0.07 |
| SF11-A12-22A SF870N | 0.19 |
| SF12-A13-22A SF870N | 0.13 |

As may be seen from the results in Table 19, all of the products tested were low in sodium.

### Example 32

This Example illustrates HPLC profile characteristics of products prepared as described in Examples 1-13.

HPLC profiles for the protein products were determined by size exclusion chromatography using a Varian ProStar HPLC system equipped with a 300×7.8 mm Phenomenex Yarra SEC-2000 series column. The column contained hydrophilic bonded silica rigid support media, 3 micron diameter, with 145 Angstrom pore size.

0.05M phosphate/0.15M NaCl, pH 6 containing 0.02% sodium azide was used as the mobile phase. Protein samples were mixed with RO water to a concentration of 1% w/v and mixed with a vortex mixer. The samples were allowed to sit for 30 minutes with periodic vortexing. They were then filtered using 0.45 μm pore size filter discs. Sample injection size was 50 μL. The mobile phase flow rate was 1 mL/minute and components were detected based on absorbance at 280 nm. The ProStar system was used to determine retention times for peaks and the peak areas. Based on the elution of protein standards of known molecular weight, it was believed that the protein component of the samples eluted within 10 minutes under the specified run conditions.

Results are shown in Table 20 below.

TABLE 20
HPLC profile information for sunflower protein products

| | Retention time | Peak area | % of total peak area |
|---|---|---|---|
| | (min) for peak | (counts) for peak | attributable to peak |
| | with largest area | with largest area | with largest area |
| | that has retention | that has retention | that has retention |
| Product | time <10 min | time <10 min | time <10 min |
| SF06-G06-21A SF870N | 6.491 | 4,901,552 | 51.24 |
| SF09-J21-21A SF870N | 6.339 | 4,766,454 | 68.99 |
| SF10-K01-21A SF870N | 6.336 | 4,432,523 | 66.70 |
| SF08-K02-21A SF870N | 6.392 | 3,314,346 | 33.36 |
| SF08-K04-21A SF870N | 6.427 | 3,822,110 | 39.87 |
| SF11-K25-21A SF870N | 6.526 | 2,716,517 | 53.69 |
| SF11-L01-21A SF870N | 6.302 | 3,428,210 | 52.23 |
| SF11-L16-21A SF870N | 6.321 | 3,379,934 | 61.37 |
| SF11-A12-22A SF870N | 6.381 | 3,345,948 | 54.09 |
| SF12-A13-22A SF870N | 6.273 | 2,969,707 | 60.72 |
| SF11-A17-22A SF870N | 6.313 | 3,155,920 | 57.67 |
| SF08-B28-22A SF870N | 6.613 | 3,598,605 | 31.87 |
| SF13-C07-22A SF870N | 6.699 | 3,760,832 | 35.25 |
| SF11-A20-22A SF870N | 6.253 | 3,076,427 | 58.51 |
| SF11-A12-22A SF870PN | 6.319 | 622,897 | 9.93 |

As may be seen from the results in Table 20, the peak with the largest area of those that had a retention time of less than 10 minutes, had a similar retention time for all samples tested.

It will be appreciated that the term “about” applies to all reported measurements and calculations. Such a term accounts for instrumental and measurement error as would be appreciated and comprehended by those in the intended field.

It will be appreciated that the examples and embodiments disclosed herein are intended to be non-limiting. They are illustrative of the invention and may be modified or altered. Such modifications and alterations within the concept and spirit of the intended invention.

We claims:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. A process for preparing a sunflower protein product from a sunflower protein source, the sunflower protein product having a protein content of greater than 60 wt % (N×6.25) d.b, the process comprising
h) extracting sunflower protein from a sunflower protein source to cause solubilization of the sunflower protein from the sunflower protein source to produce an aqueous phase and a residual sunflower protein source;
i) separating the aqueous phase from the residual sunflower protein source, optionally by centrifugation, optionally with a decanter centrifuge and a disc stack centrifuge, to produce an aqueous sunflower protein solution and a separated residual sunflower protein source
j) optionally defatting the separated aqueous sunflower protein solution to at least partially remove fat from the separated aqueous sunflower protein solution;
k) optionally adjusting the pH of the aqueous sunflower protein solution to a higher value not exceeding about pH 8.0;
l) optionally concentrating the aqueous sunflower protein solution to provide a concentrated sunflower protein solution having a protein concentration of about 5 to about 30 wt %, preferably about 5 to about 20 wt %, more preferably about 10 to about 20 wt %;
m) optionally diafiltering the concentrated sunflower protein solution using water as the diafiltration solution OR diafiltering the aqueous sunflower protein solution prior to concentration or diafiltering the partially concentrated aqueous sunflower protein solution;
n) optionally drying the sunflower protein solution or optionally concentrated and/or diafiltered sunflower protein solution, optionally by any conventional means such as spray drying or freeze drying, to provide a sunflower protein product;
wherein steps e) and f) may optionally be carried out simultaneously.

84. The process of claim 83, wherein defatting of the separated aqueous sunflower protein solution is achieved by centrifugation and/or filtration and optionally wherein defatting comprises the use of a three-phase centrifuge, such as a three-phase separator, for the simultaneous separation of fat and residual solids from the protein solution.

85. The process of claim 83, wherein a pH of the extraction may be the natural pH of the combination of the water and the sunflower protein source, or the pH of the extraction may be adjusted up to any value between the natural pH and about 8.0, or the pH may be adjusted within the range of about 6.8 to about 8.0, or the pH may be adjusted to about 6.8 to about 7.5.

86. The process of claim 83, wherein solubilization of the protein is effected at a temperature of from about 1° to about 100° C., preferably about 15° to about 65° C., more preferably about 50° C. to about 60° C., optionally accompanied by agitation, and/or the solubilization time is about 1 to about 60 minutes, preferably about 10 to about 30 minutes.

87. The process of claim 83, wherein the water of extraction may contain an antioxidant, such as ascorbic acid optionally in an amount of from about 0.01 to about 1 wt % of the solution, preferably about 0.05 wt % to about 0.15 wt %, more preferably about 0.05 wt % to about 0.10 wt %.

88. The process of claim 83, wherein the concentration step and/or the diafiltration step are effected in such a manner that the sunflower protein product subsequently recovered contains at least about 60 wt %, at least about 65 wt %, at least about 70 wt %, at least about 75 wt %, at least about 80 wt %, at least about 85 wt %, or greater than about 90 wt % protein (N×6.25) d.b.

89. The process of claim 83, wherein the optionally concentrated and optionally diafiltered protein solution is pasteurized prior to optional drying or further processing and wherein pasteurization optionally comprises heating the optionally concentrated and optionally diafiltered sunflower protein solution to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° to about 35° C.

90. The process of claim 83, further comprising the steps of:
bi) optionally further processing the separated residual sunflower protein source obtained in step b), such as to recover residual protein;
bii) optionally re-extracting the separated residual sunflower protein source obtained in step b) with fresh water to recover residual protein and separating the re-extraction protein solution from the residual sunflower protein source and optionally combining the re-extraction protein solution with the aqueous sunflower protein solution for further processing;
biii) optionally using the separated residual sunflower protein source obtained in step b) or step bi) or step bii) as an ingredient in foods, and optionally the separated residual sunflower protein source is pasteurized and/or dried before use as an ingredient in foods, and optionally the sunflower protein source is dehulled material and optionally wherein the separated residual sunflower protein source has a protein content of less than about 55% (N×6.25) d.b., preferably about 20.04 to about 46.36% (N×6.25) d.b.; and/or
biv) optionally using the separated residual sunflower protein source obtained in step b) or step bi) or step bii) as an ingredient in a pet food, animal feed, industrial product, cosmetic product or personal care product.

91. The process of claim 83, wherein finer solids are captured separately from the bulk of the separated residual sunflower protein source in step b), optionally by the disc stack centrifuge, are optionally diluted with water, optionally RO water, then optionally dried to form a sunflower protein product having a protein content of at least about 45 wt % (N×6.25), preferably at least about 50, 55 or 60 wt % (N×6.25) d.b., more preferably at least about 65 wt % (N×6.25) d.b., optionally wherein the pH of the optionally diluted finer solids is raised to a value between the natural pH of the solids and a pH of about 8.0, by any conventional means such as by the addition of sodium hydroxide, potassium hydroxide or any other conventional food grade alkali and combinations thereof, prior to optional drying to form a sunflower protein product having a protein content of at least about 45 wt % (N×6.25), preferably at least about 50, 55 or 60 wt % (N×6.25) d.b., more preferably at least about 65 wt % (N×6.25) d.b.

92. The process of claim 83, wherein the finer solids captured separately from the bulk of the separated residual sunflower protein source in step b), optionally by the disc stack centrifuge, are washed in order to remove contaminants and improve the purity and flavour of the product, optionally by suspending the solids in between about 1 and about 20 volumes, preferably about 1 to about 10 volumes of wash solution such as water, preferably RO water, and optionally the washing step is conducted at any conventional temperature such as about 15° to about 65° C., preferably about 50° to about 60° C., and optionally for any conventional length of time, preferably 15 minutes or less, then a separation step is performed by any conventional means such as by centrifugation using a disc stack centrifuge to provide washed finer solids and a used wash solution, and wherein the used wash solution is optionally added to the aqueous sunflower protein solution arising from the separation step b) for further processing, and optionally wherein the washed finer solids are optionally diluted with water then optionally dried by any conventional means such as spray drying or freeze drying to provide a sunflower protein product having a protein content of at least about 45 wt % (N×6.25) d.b., preferably about 50, 55, 60 or 65 wt % (N×6.25) d.b., more preferably about 70 wt % (N×6.25) d.b., and optionally wherein the pH of the optionally diluted washed finer solids is adjusted to a value between the natural pH of the mixture of finer solids and water and about 8.0, by any conventional means such as by the addition of sodium hydroxide, potassium hydroxide or any other conventional food grade alkali and combinations thereof, prior to optional drying or the finer solids are pH adjusted during the washing step by adjusting the mixture of finer solids and wash solution to a pH between the natural pH of the mixture and about 8.0 using food grade alkali solution, then separating the washed solids from the used wash solution by centrifugation and optionally diluting the washed solids with water and optionally drying the washed solids.

93. A sunflower product having:
a solubility of about 9.5 to about 17.6% when measured at pH 4, about 4.9 to about 14.7% when measured at pH 5.5 and about 22.4 to about 36.8% when measured at pH 7; or a solubility of less than about 70% when measured at pH 4, less than about 25% when measured at pH 5.5 and greater than about 50% when measured at pH 7, preferably about 0.8 to about 67.5% when measured at pH 4, about 6.6 to about 19.9% when measured at pH 5.5 and about 53.7 to about 97.8% when measured at pH 7 and optionally a solubility of about 46.3 to about 67.5% when measured at pH 4, about 10.4 to about 19.9% when measured at pH 5.5 and about 53.7 to about 97.8% when measured at pH 7;
an amino acid profile for cysteine and methionine as defined in Table 8; and/or an amino acid profile for threonine, valine, isoleucine, leucine, tyrosine, phenylalanine, lysine, histidine, cysteine, methionine and tryptophan as defined in Table 8;
a phytic acid content of less than about 1.5% d . . . b., preferably less than about 0.97% d.b.;
a chlorogenic acid content of less than about 10,000 ppm d.b., preferably less than about 9,518 ppm d.b., optionally less than about 565 ppm d.b., optionally wherein the chlorogenic acid content is between about 179 to about 565 ppm d.b.;
an ash content of 3% d.b. or less, preferably about 2.75% d.b. or less;
a sodium content of less than about 0.4% d.b., preferably less than about 0.19% d.b.; or
a HPLC profile as determined by the method in Example 32, wherein the peak having the largest peak area with a retention time of less than 10 minutes has a retention time of about 6.253 to about 6.699 minutes and a peak area of about 2,716,517 to about 4,901,552;
and/or which is optionally derived from confectionery or non-oilseed or black oil or oilseed or conoil sunflower seed or which is optionally derived from dehulled sunflower seed, or which is optionally derived from a partially or fully defatted sunflower protein source; or any combination thereof.

94. A residual sunflower protein product comprising a protein content of less than about 55% (N×6.25) d.b., preferably about 20.04 to about 46.36% (N×6.25) d.b., and optionally
wherein the sunflower protein source material is dehulled material and the residual sunflower protein source material is optionally pasteurized and optionally dried and optionally combined with captured finer solids.

95. A sunflower protein product or a residual sunflower protein product having an attribute from one or more of the following tables:
a protein content as defined in or captured by Table 2;
a solubility as defined in or captured by Table 3,
a dry colour as defined in or captured by Table 4;
a water binding capacity as defined or captured by Table 5;
an oil binding capacity as defined in or captured by Table 6;
a phytic acid content as defined in or captured by Table 7;
an amino acid profile comprising one or more amino acids as defined or captured by Table 8;
a chlorogenic acid content as defined or captured by Table 9;
an acid hydrolysis fat content as defined or captured by Table 10;
an ash content as defined or captured by Table 11;
a viscosity as defined or captured by Table 12;
an emulsion absorbance reading as defined or captured by Table 13
a sodium content as defined or captured by Table 19; and/or
an HPLC profile as defined or captured by Table 20.

96. A pet food, animal feed, industrial product, cosmetic product or personal care product comprising a sunflower protein product having a protein content of greater than 60 wt % (N×6.25) d.b. and produced by a process comprising
a) extracting sunflower protein from a sunflower protein source to cause solubilization of the sunflower protein from the sunflower protein source to produce an aqueous phase and a residual sunflower protein source;
b) separating the aqueous phase from the residual sunflower protein source to produce an aqueous sunflower protein solution and a separated residual sunflower protein source
c) optionally defatting the separated aqueous sunflower protein solution to at least partially remove fat from the separated aqueous sunflower protein solution;
d) optionally adjusting the pH of the aqueous sunflower protein solution to a higher value not exceeding about pH 8.0;
e) optionally concentrating the aqueous sunflower protein solution to provide a concentrated sunflower protein solution having a protein concentration of about 5 to about 30 wt %, preferably about 5 to about 20 wt %, more preferably about 10 to about 20 wt %;
f) optionally diafiltering the concentrated sunflower protein solution using water as the diafiltration solution OR diafiltering the aqueous sunflower protein solution prior to concentration or diafiltering the partially concentrated aqueous sunflower protein solution;
g) optionally drying the sunflower protein solution or optionally concentrated and/or diafiltered sunflower protein solution, optionally by any conventional means such as spray drying or freeze drying, to provide a sunflower protein product;
wherein steps e) and f) may optionally be carried out simultaneously,
and/or,
a sunflower protein product having a solubility of less than about 70% when measured at pH 4, less than about 25% when measured at pH 5.5 and greater than about 50% when measured at pH 7, preferably about 0.8 to about 67.5% when measured at pH 4, about 6.6 to about 19.9% when measured at pH 5.5 and about 53.7 to about 97.8% when measured at pH 7, or a residual sunflower protein product comprising a protein content of less than about 55% (N×6.25) d.b., preferably about 20.04 to about 46.36% (N×6.25) d.b., or
a sunflower protein product having a solubility of about 9.5 to about 17.6% when measured at pH 4, about 4.9 to about 14.7% when measured at pH 5.5 and about 22.4 to about 36.8% when measured at pH 7.

97. A food or beverage comprising:
a sunflower protein product having a protein content of greater than 60 wt % (N×6.25) d.b, and produced by a process comprising
h) extracting sunflower protein from a sunflower protein source to cause solubilization of the sunflower protein from the sunflower protein source to produce an aqueous phase and a residual sunflower protein source;
i) separating the aqueous phase from the residual sunflower protein source to produce an aqueous sunflower protein solution and a separated residual sunflower protein source
j) optionally defatting the separated aqueous sunflower protein solution to at least partially remove fat from the separated aqueous sunflower protein solution;
k) optionally adjusting the pH of the aqueous sunflower protein solution to a higher value not exceeding about pH 8.0;
l) optionally concentrating the aqueous sunflower protein solution to provide a concentrated sunflower protein solution having a protein concentration of about 5 to about 30 wt %, preferably about 5 to about 20 wt %, more preferably about 10 to about 20 wt %;
m) optionally diafiltering the concentrated sunflower protein solution using water as the diafiltration solution OR diafiltering the aqueous sunflower protein solution prior to concentration or diafiltering the partially concentrated aqueous sunflower protein solution;
n) optionally drying the sunflower protein solution or optionally concentrated and/or diafiltered sunflower protein solution, optionally by any conventional means such as spray drying or freeze drying, to provide a sunflower protein product;
wherein steps e) and f) may optionally be carried out simultaneously, and/or
a sunflower protein product having a solubility of less than about 70% when measured at pH 4, less than about 25% when measured at pH 5.5 and greater than about 50% when measured at pH 7, preferably about 0.8 to about 67.5% when measured at pH 4, about 6.6 to about 19.9% when measured at pH 5.5 and about 53.7 to about 97.8% when measured at pH, or
a residual sunflower protein product comprising a protein content of less than about 55% (N×6.25) d.b., preferably about 20.04 to about 46.36% (N×6.25) d.b., or
a sunflower protein product having a solubility of about 9.5 to about 17.6% when measured at pH 4, about 4.9 to about 14.7% when measured at pH 5.5 and about 22.4 to about 36.8% when measured at pH 7;
wherein optionally the food or beverage is:
i) a dairy alternative,
j) a meat alternative,
k) a seafood alternative,
l) a grain product,
m) a snack or sweet,
n) a fats and oils product,
o) a condiment or sauce, or
p) a nutritional product,
q) a sports drink;
r) an energy drink; or
s) a smoothie.
